(19) United States
(12) Patent Application Publication
(10) Pub. No.: US 2026/0340833 A1
(43) Pub. Date: Oct. 29, 2026

(54) UTILIZING REGIONS OF INTEREST OF ELECTROMAGNETIC SIGNALS TO PERFORM COLLECTIVE OPERATIONS

(71) Applicant: Microsoft Technology Licensing, LLC, Redmond, WA (US)

(72) Inventor: Teresa A. NICK, Towson, MD (US)

(73) Assignee: Microsoft Technology Licensing, LLC, Redmond, WA (US)

(21) Appl. No.: 19/187,162

(22) Filed: Apr. 23, 2025

(51) Int. Cl. G06T 7/11; G06N 3/045

(52) U.S. Cl. CPC G06T 7/11; G06N 3/045; G06T 2207/20104

(57) ABSTRACT

A method of performing a collective operation using electromagnetic energy includes displaying a first encoded electromagnetic signal representing a first value encoded via a property of electromagnetic energy as a first pattern of one or more entries and displaying a second encoded electromagnetic signal representing a second value encoded via the property of electromagnetic energy as a second pattern of one or more entries. The method includes detecting, at a set of regions of interest, the property of electromagnetic energy of a first entry of the first pattern and of the second pattern and determining a count for a first index position based on counting the properties of electromagnetic energy detected for the first entry of the first pattern and of the second pattern. The method includes determining a sum value of the first and second values based on the count and a multiplication factor for the first index position.

### BACKGROUND OF THE DISCLOSURE

Artificial intelligence (AI) is used to perform complex tasks such as reading comprehension, language translation, image recognition, or speech recognition. Artificial intelligence systems, such as those based on Natural Language Processing (NLP), Recurrent Neural Networks (RNNs), Convolutional Neural Networks (CNNs), Long Short-Term Memory (LSTM) neural networks, or Gated Recurrent Units (GRUs) have been deployed to perform such complex tasks. In many such systems, parallelism is used to accelerate operations associated with the model. Parallel operations are utilized for processing information (e.g., inputs or embeddings) though the various layers of the model and loading memory to perform these operations can present significant bottlenecks, which ultimately degrades performances of artificial intelligence systems during both inference and training.

Accordingly, there is a need for systems and methods that reduce latencies in artificial intelligence models.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example embodiments, the embodiments will be described and explained with additional specificity and detail through the use of the accompanying drawings in which:

FIG. 1 illustrates an example system environment 100 for performing collective operations associated with artificial intelligence (AI) using a property of electromagnetic energy, according to at least one embodiment of the present disclosure;

FIG. 2 illustrates an example set of signals that are communicated using electromagnetic energy to perform collective operations associate with AI, according to at least one embodiment of the present disclosure;

FIG. 3 illustrates a binary encoding scheme which may be used for encoding and displaying electromagnetic signals as part of a collective operation, according to at least one embodiment of the present disclosure;

FIG. 4 illustrates an example process for determining a sum value by scanning various sets of regions of interest across one or more displays, according to at least one embodiment of the present disclosure;

FIG. 5-1 illustrates an example of various nodes of a Layer L-1 and various nodes of a layer L, and connections therebetween, according to at least one embodiment of the present disclosure;

FIG. 5-2 illustrates an electromagnetic signal representing various weighted activations in relation to the architecture of FIG. 5-1.

FIGS. 6-1 to 6-4 illustrate an example of a system performing a collective operation using electromagnetic signals, according to at least one embodiment of the present disclosure;

FIG. 7 illustrates another example of a system for performing a collective operation using electromagnetic signals, according to at least one embodiment of the present disclosure;

FIG. 8 illustrates a flow diagram for a method or a series of acts for performing a collective operation using electromagnetic energy, according to at least one embodiment of the present disclosure; and

FIG. 9 illustrates certain components that may be included within a computing system.

### DETAILED DESCRIPTION

The present disclosure relates to performing collective operations associated with a machine learning (ML) or artificial intelligence (AI) model using a property of electromagnetic energy. Collective operations include operations that allow collection of data from different nodes, neurons, or processing units for combining into a result for (the same or different) nodes, neurons, or processing units. For example, data from one or more processing units (e.g., GPUs) associated with one portion of the AI system may be combine into a result for another portion of the AI system. As an example, during inference, a layer of an AI model provides results of a computation by neurons in that layer to the neurons for the next layer. This means that all of the computations from a layer (e.g., layer L-1) would have to be supplied to each processing unit that would perform the next layer's (layer L) computations. As used herein the term “neuron” or “node” refers to a connection point or computational unit in an artificial intelligence system having layers for processing inputs and providing outputs, where the neuron has the capability to receive an input and provide an output to other connection points in the AI system.

Similarly, during training as part of backpropagation, model parameters are synchronized by exchanging updated gradients. Parameter updates are applied during backpropagation. Thus, during training as part of a backward pass a layer of an AI model provides results of the computation by neurons in that layer to the neurons for the previous layer. As an example, the gradient of a loss function with respect to the weights in the network (or a portion of the network) is calculated. The gradient is then fed to an optimization method that uses the gradient to update the weights to minimize the loss function. The goal with backpropagation is to update each of the weights (or at least some of the weights) in the network so that they cause the actual output to be closer to the target output, thereby minimizing the error for each output neuron and the network as a whole.

In one example, using the systems and methods described herein, the summation of weighted activations can be processed as part of a collective operation by leveraging the display of electromagnetic signals which are encoded representations of the weighted activations. The summation is then transmitted to the next nodes and/or layer. In some cases, the summation of the weighted activations is transmitted to the next nodes and/or layer without transmitting the weighted activations themselves. In some instances, control planes may not be necessary because the processing units can either be pre-programmed to process a defined part of the model (inference) or self-organize and parallelize the model based on the size of their allotted data partition (training). Although transmission bandwidth as described herein may be limited by visible light peripherals, such as displays and image sensors operating based on visible light, that are optimized for relatively slow human vision, this limit does not present a technological barrier. For example, in some embodiments, peripherals for generating electromagnetic energy signals (e.g., displays) and for receiving or sensing electromagnetic energy signals (e.g., image or light sensors) may be implemented which may operate based on electromagnetic energy that is not in the visible spectrum and/or optimized for speeds above that which human vision can detect. For instance, electromagnetic energy from at least infrared rays to ultraviolet rays, including visible light, may be used with the systems and methods described herein. In terms of wavelength, the electromagnetic energy may range from nanometers (e.g., 400 nanometers) to a few microns (e.g., 1.6 microns). The specific range of wavelength that is used will depend on the type of displays, sensors, or other such equipment being used for the communication of the electromagnetic energy. As an example, radiofrequency waves in a range of 3 kHz to 300 MHz may be used. As another example, microwaves in a range of 300 MHz to 300 GHz may also be used. Depending on the frequency, and thus the wavelength, of the electromagnetic energy being used, the equipment used for communicating such signals may be tailored.

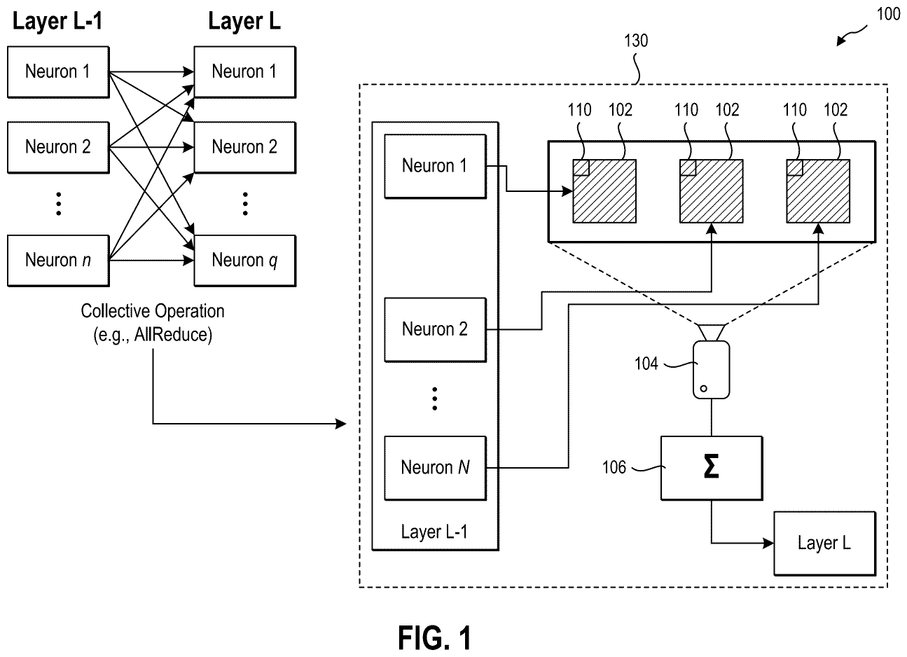

FIG. 1 illustrates an example system environment 100 for performing collective operations associated with artificial intelligence (AI) using a property of electromagnetic energy, according to at least one embodiment of the present disclosure. In some cases, system environment 100 relates to an artificial intelligence system that, once trained, can be used for predicting outputs as part of inference. System environment 100 shows the model as including layers L-1 and L, where layer L-1 includes several neurons (neuron 1, neuron 2, and neuron N) and layer L includes several neurons (neuron 1, neuron 2, and neuron Q). For neuron 1 in layer L, the activation is equal to an activation function (Ø) on the sum of all weighted inputs or weighted activations (aw) to neuron 1 with some bias b:

$${a}_{1}^{( l )} = ∅ ( {a}_{1}^{( l - 1 )} {w}_{1 , 1}^{( l )} + {a}_{2}^{( l - 1 )} {w}_{2 , 1}^{( l )} + … + {a}_{n}^{( l - 1 )} {w}_{n , 1}^{( l )} + {b}^{( l )} ) .$$

The inputs

$$( e . g . , {a}_{1}^{( l - 1 )} , {a}_{2}^{( l - 1 )} , and {a}_{n}^{( l - 1 )} )$$

in this example are the set of values for which one needs to predict an output value. These can be viewed as features or attributes included in the data. The weights

$$( e . g . , {w}_{1 , 1}^{( l )} , {w}_{2 , 1}^{( l )} , and {w}_{n , 1}^{( l )} )$$

are values that are attached to each input to convey the importance of the corresponding input or feature in predicting the final output. The bias (e.g., b^{(l)}) can be used to shift the activation function towards left or right. The weights and the bias are parameters that have been learned during training of the AI model.

The activation function (e.g., Ø) is used to introduce non-linearity in the model and the summation function is used to bind the weights and inputs together. Examples of activation functions include rectified linear unit (ReLU) activation function, leaky ReLU, parametric ReLU, Gaussian-error linear unit (GELU) activation function, and other variants of ReLU. Moreover, aside from ReLU any other appropriate non-linear or linear activation functions may be used. In this example, in order to calculate the summation for a node of layer L (e.g.,

$${a}_{1}^{( l )}$$

for neuron 1), one needs information across all of layer L-1, even if the neurons in layer L-1 are partitioned across processing units as part of parallelism. This means that in this example all of the layer L-1 activations would have to be supplied to each processing unit that would calculate layers L's

$${a}_{1}^{( l )} to {a}_{q}^{( l )} .$$

In some conventional solutions, in order to communicate the data (e.g., activations) from the nodes of layer L-1 to layer L (e.g., between processing units operating these various nodes and/or layers), the data is transmitted through the neural network by traditional electronic means. For example, after computing the activations for its own nodes, the layer L-1 must serialize and transmit the data to the layer L, where they must be stored in memory or storage. Additionally, to process the activation function and compute the activations for the nodes of layer L, the layer L (e.g., one or more processing units) must recall each of the relevant activations from layer L-1, and compute the activation function on those activations (e.g., including applying corresponding weights to the activations) in order to produce sum values representing the activations for the nodes for layer L.

The flow of information across the neural network and the operation of the AI model as a whole in this way can typically be very memory and computation expensive. For example, it is not uncommon for modern AI models to have trillions of parameters (e.g., nodes), resulting in millions or even billions of computations (e.g., activation functions) to perform at each layer. While GPUs are typically leveraged for their ability to perform large amounts of parallel operations efficiently, even still, the sheer volume of computations to be performed can present a considerable bottleneck to the operation of an AI model. Indeed, in addition to the actual computing of the activation functions, this large volume of data has to be serialized and transmitted to the next layer of the model, which at the scale of millions or billions of activations per layer, can result in significant latency issues.

The delay associated with this computation aspect of AI models is even further exacerbated by bottlenecks associated with memory functions. For example, even given that GPUs may be particularly suited for performing a large number of computations, fetching, and storing data from memory can introduce even more significant latency issues. For instance, moving data between GPUs (or other processing units) and VRAM (or other memory) is often orders of magnitude slower than the computations themselves. Indeed, a considerable amount of the bottleneck/latency issues with AI models is often attributable to the delay in memory access functions. Moreover, AI models require a significant amount of memory resources to store weights, activations, and other data. As memory hardware resources are typically limited, and the volume of data utilized by AI models is continually growing, data overflows spill to slower memory or other storage devices, causing further delays.

The techniques of the present disclosure facilitate performing collective operations or computations (e.g., summing weighted activations) at a layer of an AI model, as well as consolidating the data to be transmitted between layers, to reduce or mitigate latency issues associated with AI models. For example, by displaying the weighted activations as encoded electromagnetic signals, and bitwise summing the weighted activations with an image sensor detecting the electromagnetic signals, the data that is typically transmitted between layers (e.g., each of the weighted activations) can effectively be consolidated to a single sum value (e.g., a single sum value for each receiving node) providing significant savings associated with transmission bandwidth, serialization, memory access, and other functionalities. Indeed, in many cases, a layer (e.g., layer L) may process activation functions and determine activations for its nodes without actually having received the underlying activations from the previous layer (e.g., layer L-1), but rather based on receiving a (e.g., single) sum value for each receiving node. In this way, the collective operations via displayed electromagnetic signals as described herein may facilitate a more efficient operation of AI models by consolidating and streamlining the transmission of data between layers. As used herein, an “activation,” “activation value,” or the like may refer to any input value which is received, determined, or which applies specifically to a node of an AI model. For example, an activation may be any value (e.g., number) which is generated and/or received by any portion of an AI model and may not be limited to only being activation values, for instance, as part of an inferencing operation of an AI model. Also, as used herein, “weight,” “weight value,” or the like may refer to any learned parameter by an AI model. For example, a weight may be any parameter (e.g., number) which is static, known, or learned and which corresponds to an input value for adjusting, modifying, or otherwise weighing the input value. Accordingly, a weighted activation may be any value or input which is multiplied, weighted, adjusted, or modified by a learned parameter (e.g., a weight), such as are processed by neurons of an AI model.

The system environment 100 shows system 130, which is one example implementation for performing the collective operation as part of the AI system. System 130 may include one or more processing units for implementing, hosting, or operating the various nodes or neurons of the model. Each of the processing units can be a graphics processing unit (GPU), or may be implemented using other hardware options, as well, such as one or more computer processing units (CPUs), field programmable gate arrays (FPGAs), application specific integrated circuits (ASICs), erasable and/or complex programmable logic devices (PLDs), programmable array logic (PAL) devices, or generic array logic (GAL) devices.

In some embodiments, a processing unit may be configured to process one or more neurons associated with a layer. As an example, assuming there are 256 neurons in layer L, the 256 neurons may be hosted or processed by one, or multiple processing units. Partitioning may be performed using code configured to partition the model based on machine language frameworks, such as Tensorflow, Apache MXNet, and Microsoft® Cognitive Toolkit (CNTK). Thus, the various layers of the model may be assigned for processing using different processing units. This way the various parameters associated with layers may be processed in parallel.

In one example, the neural network model may comprise of many layers and each layer may be encoded as matrices or vectors of weights expressed in the form of coefficients or constants that have been obtained via training of a neural network. Taking the LSTM example, an LSTM network may comprise a sequence of repeating RNN layers or other types of layers. Each layer of the LSTM network may consume an input at a given time step, e.g., a layer's state from a previous time step, and may produce a new set of outputs or states. In the case of using the LSTM, a single chunk of content may be encoded into a single vector or multiple vectors. As an example, a word or a combination of words (e.g., a phrase, a sentence, or a paragraph) may be encoded as a single vector. Each chunk may be encoded into an individual layer (e.g., a particular time step) of an LSTM network. An LSTM layer may be described using a set of equations, such as the ones below:

iₜ=σ(Wₓᵢxt+Wₕᵢhₜ₋₁+W_{ci}cₜ₋₁+bᵢ)

fₜ=σ(W_{xf}xₜ+W_{hf}hₜ₋₁+W_{cf}cₜ₋₁+b_{f})

cₜ=fₜcₜ₋₁iₜ tanh(W_{xc}xₜ+W_{hc}hₜ₋₁+b_{c})

oₜ=σ(Wₓₒxₜ+Wₕₒhₜ₋₁+W_{co}cₜ+bₒ)

hₜ=oₜ tanh(cₜ)

In this example, inside each LSTM layer the inputs and hidden states may be processed using a combination of vector operations (e.g., dot-product, inner product, or vector addition) and non-linear functions. In certain cases, the most compute intensive operations may arise from the dot products, which may be implemented using dense matrix-vector and matrix-matrix multiplication routines. Although FIG. 1 shows system 130 as including certain components that are arranged in a certain manner, system 130 may include additional or fewer components arranged differently.

System 130 and the associated models can be deployed in cloud computing environments. Cloud computing may refer to a way for enabling on-demand network access to a shared pool of configurable processing units. For example, cloud computing can be employed in the marketplace to offer ubiquitous and convenient on-demand access to the shared pool of configurable processing units. The shared pool of configurable processing units can be rapidly provisioned via virtualization and released with low management effort or service provider interaction, and then scaled accordingly. A cloud computing model can be composed of various characteristics such as, for example, on-demand self-service, broad network access, resource pooling, rapid elasticity, measured service, and so forth. A cloud computing model may be used to expose various service models, such as, for example, Hardware as a Service (“HaaS”), Software as a Service (“SaaS”), Platform as a Service (“PaaS”), and Infrastructure as a Service (“IaaS”). A cloud computing model can also be deployed using different deployment models such as private cloud, community cloud, public cloud, hybrid cloud, and so forth.

As mentioned, the various neurons 1-N for layer L-1 may have weighted activations for summing and transmitting to the various nodes of Layer L. The neurons of layer L-1 may each present or display an encoded electromagnetic signal representative of their weighted activation(s). For example, one or more processing units may be coupled to display devices for displaying the electromagnetic signals 102 on one or more displays, screens, or other spaces. In one example, the display devices include projector displays for projecting onto a screen. In other examples, the display devices include emitter displays (LED display, LCD display, etc.) having one or more emitters for displaying electromagnetic signals via the emitters. The display(s) may be implemented via display links such as display port links, peripheral component interconnect express (PCIe) links, HDMI links, or other high-speed links. In some cases, the electromagnetic signals 102 for each neuron are displayed on a separate display, screen, or space, or two or more electromagnetic signals 102 may be displayed on a same display, screen, or space.

The electromagnetic signals 102 may be encoded electromagnetic signals which may comprise a pattern, shape, array, matrix, or other form, encoded for presenting a value (e.g., a decimal number of a weighted activation) via a property of electromagnetic energy. For instance, as described below in greater detail, in some cases the electromagnetic signals 102 are a pattern of entries (e.g., pixels, regions, discrete locations representing bits) each having a selected light intensity or brightness to represent a bit of a bit pattern encoding the underlying value. Thus, by observing or detecting the light intensity at certain regions of interest of the electromagnetic signals corresponding to indexed locations of the entries of the associated encoding scheme, the various bits may be identified and the underlying value determined. The electromagnetic signals 102 may each be presented at a discrete, separate location, such that the electromagnetic signals 102 are not collocated, or do not overlap. Accordingly, the weighted activations for each neuron of layer L-1 can be displayed via encoded electromagnetic signals 102.

The system 130 includes an image sensor 104 which may observe the various displays and may detect the displayed electromagnetic signals 102. For instance, the image sensor 104 may be one or more of a camera, light sensor, photodetector, or other image sensor. The image sensor 104 may detect the displayed electromagnetic signals 102 and may determine a sum of the underlying values (e.g., weighted activations) for transmitting to the layer L. For instance, the image sensor 104 may include a processor (e.g., FPGA) which may operate in-line with the image sensor 104 to perform the collective operation as described herein for transmitting the sum value 106 to the layer L.

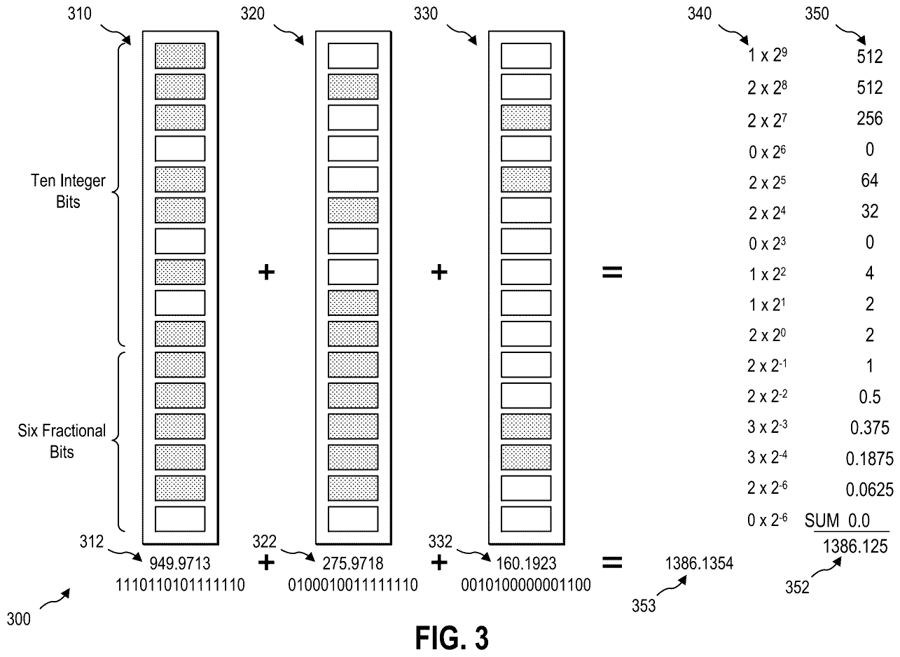

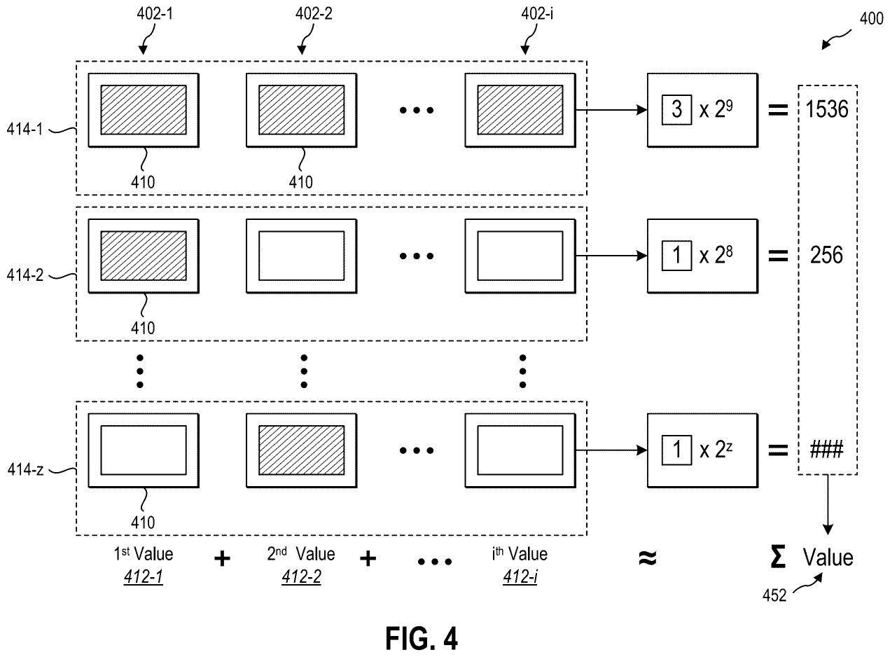

The image sensor 104 may determine the sum value 106 based on observing various regions of interests 110 of the electromagnetic signals 102 and determining a count for various index positions corresponding with the encoding of the electromagnetic signals 102. For example, the image sensor 104 may observe, at a set of regions of interest 110, a single entry of each of the electromagnetic signals and may determine an overall count (e.g., among the regions of interests 110) for that index position to utilize in determining the sum value 106. Based on determining a count, entry by entry, for each index position, and utilizing a multiplication factor for each index position, the image sensor 104 (e.g., the associated processor) can estimate, approximate, or determine the sum value 106. More details regarding the regions of interest and the entry-wise summation of the electromagnetic signals to determine the sum value is described below in connection with FIGS. 3-4. This technique of determining the sum value 106 via discrete entries and regions of interest may be in contrast to, for example, simply detecting each electromagnetic signal (e.g., as a whole), identifying the underlying value, and summing the values in a typical computer computation. Rather, by detecting, entry-wise, the light intensity at each region of interest to determine a count for each index position, large scale summation can be achieved without loading and recalling numerous weighted activation values from memory and performing a typical summation computation with a processor. Indeed, the system 130 may advantageously transmit just the sum value 106 (e.g., and sum values for all connections between nodes of the layer), rather than transmitting each of the weighted activations to the layer L to be summed. In this way, bottlenecks typically associated with both transmitting data within a neural network, as well as memory access latencies, may be reduced or mitigated for providing improvements to the operation of AI models.

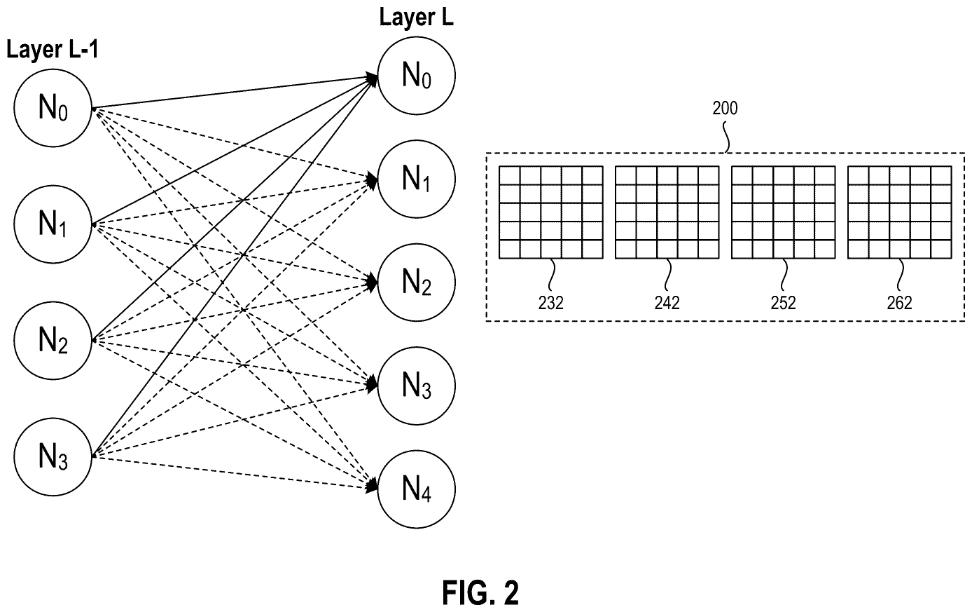

FIG. 2 shows an example set of signals that are communicated using electromagnetic energy to perform collective operations associated with artificial intelligence, according to at least one embodiment of the present disclosure. To explain the signals, four neurons N0, N1, N2, and N3 are shown for layer L-1 and five neurons N0, N1, N2, N3, and N4 are shown for layer L. This example relates to inference and shows the use of the electromagnetic energy's use in the context of signals being communicated from each of the four N0, N1, N2, and N3 of layer L-1 to neurons of layer L. Accordingly, the weights (w) and bias (b) are known and can simply be stored local to the processing unit corresponding to the neurons. Thus, in this example, only the new input data to be processed by the neurons in layer L needs to be sent from each of the neurons of layer L-1 to neuron N0 of layer L. Neuron N0 of layer L needs to compute

$${a}_{1}^{( l )} = ∅ ( {a}_{0}^{( l - 1 )} {w}_{0 , 1}^{( l )} + {a}_{1}^{( l - 1 )} {w}_{1 , 1}^{( l )} + {a}_{2}^{( l - 1 )} {w}_{2 , 1}^{( l )} + {a}_{3}^{( l - 1 )} {w}_{3 , 1}^{( l )} + {b}^{( l )} ) .$$

To enable this computation, neuron N0 of layer L-1 needs to send the value of

$${a}_{0}^{( 1 - 1 )} {w}_{0 , 1}^{( l )}$$

to neuron N0 of layer L. Neuron N1 of layer L-1 needs to send the value of

$${a}_{1}^{( 1 - 1 )} {w}_{1 , 1}^{( l )}$$

to neuron N0 of layer L. Neuron N2 of layer L-1 needs to send the value of

$${a}_{2}^{( 1 - 1 )} {w}_{2 , 1}^{( l )}$$

to neuron N0 of layer L. Neuron N3 of layer L-1 needs to send the value of

$${a}_{3}^{( 1 - 1 )} {w}_{3 , 1}^{( l )}$$

to neuron N0 of layer L. Neuron N0-N5 of layer L need to communicate the activation sum signals to the next layer of the model.

In this example, the luminous intensity (e.g., brightness) of the electromagnetic energy (or other property of electromagnetic energy) is used to communicate data from each of the neurons (N0, N1, N2, and N3 of layer L-1) to the neurons associated with the next layer (layer L). Display 200 is representative of one or multiple displays which may display electromagnetic signals as described herein. Display 200 shows light shapes or patterns to illustrate example signals communicated by a processing unit.

On the display 200 are presented various encoded electromagnetic signals. For example, an encoded electromagnetic signal may be displayed corresponding with each of the nodes N0-N3 of layer L-1, including electromagnetic signals 232, 242, 252, and 262. The encoded electromagnetic signals may provide information for use with the neurons in the next layer. For instance, each of the nodes associated with layer L-1 displays an encoded electromagnetic signal at a specific spot on the display 200, comprising a pattern which encodes, via light intensity (or other property), one or more of the weighted activations for that neuron and for communicating to one or more corresponding neurons of the layer L. For instance, in some cases, each electromagnetic signal may encode (e.g., via several electromagnetic signals or patterns) a weighted activation for each connection of that neuron with a neuron of the layer L. As an example, electromagnetic signal 232 may correspond with node N0 of layer L-1. Electromagnetic signal 232 may be displayed at a specific spot and may include an encoded pattern (e.g., a sequence of one or more entries) for each of the weighted activations

$${a}_{0}^{( l - 1 )} {w}_{0 , 0}^{( l )} , {a}_{0}^{( l - 1 )} {w}_{0 , 1}^{( l )} , {a}_{0}^{( l - 1 )} {w}_{0 , 2}^{( l )} , {a}_{0}^{( l - 1 )} {w}_{0 , 3}^{( l )} , and {a}_{0}^{( l - 1 )} {w}_{0 , 4}^{( l )}$$

for communicating (e.g., after summing with other associated weighted activations) to the respective nodes of the layer L. Electromagnetic signal 242 may correspond with node N1 of layer L-1. Electromagnetic signal 242 may be displayed at a specific spot and may include an encoded pattern (e.g., a sequence of one or more entries) for each of the weighted activations

$${a}_{1}^{( l - 1 )} {w}_{1 , 0}^{( l )} , {a}_{1}^{( l - 1 )} {w}_{1 , 1}^{( l )} , {a}_{1}^{( l - 1 )} {w}_{1 , 2}^{( l )} , {a}_{1}^{( l - 1 )} {w}_{1 , 3}^{( l )} , and {a}_{1}^{( l - 1 )} {w}_{1 , 4}^{( l )}$$

for communicating summing with other associated weighted activations) to the respective nodes of layer L. Electromagnetic signal 252 may correspond with node N2 of layer L-1. Electromagnetic signal 252 may be displayed at a specific spot and may include an encoded pattern (e.g., a sequence of one or more entries) for each of the weighted activations

$${a}_{2}^{( l - 1 )} {w}_{2 , 0}^{( l )} , {a}_{2}^{( 1 - 1 )} {w}_{2 , 1}^{( l )} , {a}_{2}^{( l - 1 )} {w}_{2 , 2}^{( l )} , {a}_{2}^{( l - 1 )} {w}_{2 , 3}^{( l )} , and {a}_{2}^{( l - 1 )} {w}_{2 , 4}^{( l )}$$

for communicating (e.g., after summing with other associated weighted activations) to the respective nodes of layer L. Electromagnetic signal 262 may correspond with node N3 of layer L-1. Electromagnetic signal 262 may be displayed at a specific spot and may include an encoded pattern (e.g., a sequence of one or more entries) for each of the weighted activations

$${a}_{3}^{( l - 1 )} {w}_{3 , 0}^{( l )} , {a}_{3}^{( l - 1 )} {w}_{3 , 1}^{( l )} , {a}_{3}^{( l - 1 )} {w}_{3 , 2}^{( l )} , {a}_{3}^{( l - 1 )} {w}_{3 , 3}^{( l )} , and {a}_{3}^{( 1 - 1 )} {w}_{3 , 4}^{( l )}$$

for communicating (e.g., after summing with other associated weighted activations) to the respective nodes of layer L.

As described below in more detail, one or more image sensors (e.g., cameras) may observe or view the electromagnetic signals on the various displays, and in particular, may observe portions or individual entries of the electromagnetic signals by scanning or cycling through various regions of interest. For instance, by viewing, entry-wise, the electromagnetic signals, the detected light intensity can be aggregated, counted, or summed at sets of regions of interest corresponding with specific index positions of the encoding scheme of the electromagnetic signals. In this way, a total count can be summed for each given index position of the encoding scheme in order to estimate, infer, or approximate the sum of the underlying weighted activations (e.g., the sum of all weighted activations for a given receiving node). For instance, such an operation may result in the completion of the collective operation (e.g., AllReduce) such that the sum values for the weighted activations may be transmitted to respective receiving neurons of the layer L rather than transmitting each of the underlying weighted activations, improving bandwidth and bottleneck issues.

Although FIG. 2 shows a certain number and arrangement of neurons for the layers, each layer may include additional or fewer neurons. Moreover, the neurons for different layers can be supported by the same processing unit or different processing units. In addition, although FIG. 2 shows display 200 with a certain arrangement and type of signals, display 200 may include additional or fewer signals that are arranged differently. Display 200 itself may be several displays, or any other device or structure that can be used for the presenting of the luminous intensity (or other electromagnetic properties) associated with the electromagnetic energy. For instance, in some cases, each neuron may be associated with a separate display, or each processor (e.g., hosting several neurons) may have its own display. Indeed, the electromagnetic signals 232, 242, 252, 262 may be displayed via any number of different displays.

In some cases, other types of signals may be displayed on one or more displays. For example, one or more reference signals may be displayed which may facilitate identifying a sending node or a receiving node. In some examples, one or more reference signals may be displayed which may indicate the property of electromagnetic energy (e.g., light intensity) as a reference for tallying or counting light intensity, such as for calibrating the detection by the image sensor. In some cases, one or more reference signals may be displayed for indicating which nodes have reported or participated in the collective operation. In some cases, one or more reference signals may be displayed which may facilitate synchronizing the display of electromagnetic signals across one or more displays, nodes, processors, etc.

In addition, although FIG. 2 shows the movement of data from layer L-1 to L, the movement of data may be in the opposite direction, as well. As noted earlier, during training as part of backpropagation, model parameters are updated by backflow of error gradients. Weight and bias parameter updates are applied during backpropagation. Thus, during training as part of a backward pass a layer of an AI model provides results of the loss or error computation by neurons in that layer to the neurons for the previous layer (e.g., neurons in layer L provides the results to the neurons in layer L-1 of FIG. 2). The gradient of a loss function with respect to the weights and bias in the network (or a portion of the network) is calculated. The gradient is then fed to an optimization method that uses the gradient to update the weights to minimize the loss function. The goal with backpropagation is to update each of the weights (or at least some of the weights) in the network so that they cause the actual output to be closer to the target output, thereby minimizing the error for each output neuron and the network as a whole. As used herein, the term “electromagnetic signal” described earlier refers to gradient of the error in the context of backpropagation while training the AI model. Conversely, in the context of inference the “electromagnetic signal” refers to a displayed signal of a weighted activation.

FIG. 3 shows a binary encoding scheme 300 which may be used for encoding and displaying electromagnetic signals as part of a collective operation, according to at least one embodiment of the present disclosure. In one example, electromagnetic signals may be represented as a pattern of entries, such as regions, pixels, or other bit-identifying areas, having varying light intensity for conveying bit values for a series of bits in a fixed-point binary representation for an underlying decimal value. Although floating point representation of values as part of the model processing may have slightly higher accuracy, this comes at the expense of transmission bandwidth. Accuracy and bandwidth can be optimized for each use case. To simplify the processing while maintaining a reasonable dynamic range of the values, fixed point representation of values may be used. In one example, fixed point representation may use a set number of integer bits and fractional bits to express numbers. Fixed point values can be efficiently processed in hardware with integer arithmetic, which may make it a preferred format for use with the systems described herein. Fixed point format may be represented as X.Y, where X is the number of integer bits and Y is the number of fractional bits. Block-floating point (BFP) may apply a shared exponent to a block of fixed-point numbers; for example, a vector or matrix. The shared exponent may allow a significantly higher dynamic range for the block, although individual block members have a fixed range with respect to each other. Quantization involving mapping continuous or high-precision values onto a discrete, low-precision grid, may be used to arrive at the fixed-point representations of the floating-point values. If the original points are close to their mapped quantization value, then one expects that the resulting computations will be close to the original computations.

As part of the binary encoding scheme 300 the electromagnetic signals (e.g., similar to 232, 242, 252, and 262 of FIG. 2) may be encoded using fixed-point integer values. For example, a first value 312 may be encoded as a first electromagnetic signal 310. The first value 312 may be a weighted activation for a connection between a first node and a target node. A second value 322 may be encoded as a second electromagnetic signal 320. The second value 322 may be a weighted activation for a connection between a second node and the target node. A third value 332 may be encoded as a third electromagnetic signal 330. The third value 332 may be a weighted activation for a connection between a third node and the target node. In the example shown in FIG. 3, the fixed-point integer values include ten integer bits and six fractional bits.

While the electromagnetic signals 310, 320, 330 are shown as columns, any shape, pattern, or form having various entries may be utilized for conveying the underlying values 312, 322, 332 based on specific indexed locations of the bits. Additionally, while each of the electromagnetic signals 310, 320, 330 is shown as conveying or representing a single value, in some cases the term “electromagnetic signal” as used herein may refer to a larger pattern or collection of entries which may convey multiple underlying values. For example, as shown in FIG. 2, the electromagnetic signals 232, 242, 252, 262, are shown as a larger pattern having several columns, and each column may correspond to an electromagnetic signal (like those shown in FIG. 3) representing underlying values. Accordingly, the electromagnetic signal 310 may correspond to a portion or column of the electromagnetic signal from one of the neurons of the input layer L-1. Electromagnetic signals 320 and 330 may similarly be portions of electromagnetic signals, respectively, of other neurons of the input layer L-1 as shown in FIG. 2. More details related to the form and makeup of electromagnetic signals is described below in connection with FIGS. 5-1 and 5-2.

Accordingly, the relative positioning of the entries within each electromagnetic signal may correspond with various index positions of the associated encoding scheme. For instance, the encoding scheme may define a specific number of integer bits and fractional bits, and the index position may indicate which digit or position in the binary representation of the value each bit corresponds to (e.g., 10^{th} integer bit, 9^{th} integer bit, 1^{st} fractional bit, etc.). As shown in column 340, the index position may correspond with a multiplication factor, which in some cases may be based on a binary encoding scheme. For instance, the multiplication factor may be a binary exponential multiplication factor. As an example, the index position of the tenth integer bit may correspond to a multiplication factor of 2⁹, an index position of the 9^{th} integer bit may correspond to a multiplication factor of 2⁸, and so on.

In this way, the underlying values may be represented in binary form by the electromagnetic signals. For example, at each entry of the electromagnetic signal, a light intensity may be varied to represent, in binary form, a 1 or a 0. For instance, the light intensity may be one or more of on or off, high or low, or other binary variation. Accordingly, by detecting the light intensity at each entry, a bit value of that digit (e.g., 1 or 0) may be inferred in order to determine the underlying value. For instance, as shown, the grey or darker scale may correspond with a high light intensity (e.g., 1) and the white entries may correspond with a low light intensity (e.g., 0). In some cases, other properties of electromagnetic energy may be utilized, such as a color or wavelength to indicate a binary representation as described. Indeed, while the present techniques are generally described herein with reference to a property of electromagnetic energy being a light intensity or brightness, it should be understood that the techniques described herein may be applicable to the use of color or wavelength as a distinguishing electromagnetic property for use in encoding electromagnetic signals. Also, while the encoding scheme has been described primarily as a binary scheme, additional, or other (e.g., higher order) encoding schemes may be used. For example, a base 3, base 4, or higher order encoding scheme may be utilized, such as by utilizing 2, 3, or more light intensity values, colors, or a combination thereof, for each entry. Further, in some cases negative values may be represented by one or more light intensities and/or colors. Thus, the use of the term “bit” is not intended to be limiting to only binary or base 2 encoding schemes, but rather, is used to refer to a fundamental or smallest unit of information corresponding with any encoding scheme utilized in combination with the present techniques, including higher-order encoding schemes.

As shown in column 340, a count can be determined for each index position for summing the electromagnetic signals 310, 320, 330 (e.g., for summing the values 312, 322, 332). For instance, by aggregating the count of the light intensities as each entry, a count can be summed for the associated index position. For instance, for the 10^{th} integer index position, the count is 1, for the 9^{th} integer index position the count is 2, and so on based on the identified light intensity at the respective bits of each electromagnetic signal 310, 320, 330. Based on the count and the multiplication factor, column 350 shows a computation to generate a sum value 352. In some cases, the sum value 352 may an estimate or approximation of the mathematical sum or true sum 353 of the values 312, 322, 332. For example, the sum value 352 may include an error when summing up the binary numbers. The sum value 352 may be representative of the sum of the weighted activations for one target neuron. For instance, any number of weighted activations may be generated and may be displayed for summing together to generate the sum value 352.

In some cases, other mathematical calculations may be performed. For instance, an average or mean may be determined based on dividing the sum value 352 by the total number of electromagnetic signals. For instance, the sum value 352 may be representative of any value that is ultimately determined or calculated, and then transmitted to another node or layer. In other example, other statistical values can be determined.

In some cases, the binary encoding scheme 300 may be utilized to facilitate the summing of two or more electromagnetic signals based on overlaying or collocating two or more electromagnetic signals. For instance, two or more electromagnetic signals may be projected onto a same space, or emitters for displaying each electromagnetic signal may be located in close proximity such that the output of the emitters combines to a cumulative output. For example, because the entries are encoded using a property of electromagnetic energy (e.g., light intensity), in some cases two or more electromagnetic signals may be collocated such that the associated properties of electromagnetic energy at each entry naturally aggregate, sum, combine, or add. For instance, a high, on, or 1 light intensity of one entry, when overlayed with another high, on, or 1 light intensity of another entry may combine (naturally) to an even higher light intensity, which may indicate a 2 for that combined entry or position. In some cases, an image sensor may be configured to identify several different levels of light intensity in this way such that electromagnetic signals may be added or summed by collocating the electromagnetic signals and detecting the resulting cumulative electromagnetic signal. More information regarding this cumulative effect of collocated electromagnetic signals is described in U.S. patent application Ser. No. 18/526,186, filed Dec. 1, 2023 and Ser. No. 18/737,539, filed Jun. 7, 2024, which are hereby incorporated by reference in their entireties.

In some cases, the binary encoding scheme 300 may be utilized in this way to collocate electromagnetic signals and leverage the natural combining of electromagnetic properties to perform summation operations. For instance, two or more electromagnetic signals may be collocated, overlapped, or superimposed in order to naturally sum the electromagnetic signals, and when the image sensor scans through a region of interest corresponding with the cumulative electromagnetic signal, the image sensor may detect the cumulative output of the light intensity in order to augment the count of an associated index position as described herein. This collocating of electromagnetic signals may be implemented in combination with electromagnetic signals that are not collocated, or that are located at discrete or separate locations. For example, a set of weighted activations to be summed may be represented by some electromagnetic signals that are collocated as just described, and some that are discretely located, and the image sensor may scan through sets of regions of interest as described herein in order to determine, entry-wise, a total sum for the underlying weighted activations. In this way, the present techniques may be expanded, in one or more embodiments, to leverage the benefits of generating cumulative electromagnetic signals by collocating electromagnetic signals.

FIG. 4 illustrates an example process 400 for determining a sum value 452 by scanning various sets of regions of interest across one or more displays, according to at least one embodiment of the present disclosure. The example process 400 may be in accordance with any of the embodiments and figures as described herein. For example, the example process 400 may be utilized for summing weighted activations for various nodes of a layer of an AI model for transmitting to a node of a next layer.

In the example process 400, a first value 412 may be encoded and represented as a first electromagnetic signal 402-1, a second value 412-2 as a second electromagnetic signal 402-2, and so on to an ith value 412-i as an ith electromagnetic signal 402-i (e.g., collectively values 412 and electromagnetic signals 402). Each of the electromagnetic signals 402 may be encoded via a property of electromagnetic energy as a pattern of one or more entries (e.g., pixels or regions) to indicate the underlying values 412 as described herein. In some cases, the electromagnetic signals 402 are displayed on different displays, such as each layer, processor, or node of the AI model having its own display for displaying electromagnetic signals. In some cases, two or more electromagnetic signals 402 may be displayed on a same display, such as two or more layers, nodes, or processors of the AI model sharing a same display. In some cases, the displays may all be the same type of display such as all being projector displays or all being emitter displays. In some cases, one or more of the displays is a different type of display, such as one display being a projector display and other displays being emitter displays. In this way, the process 400 may be implemented in a wide variety of applications. Indeed, the electromagnetic signals 402 may be displayed in any manner in which element-wise light intensities of the electromagnetic signals 402 may be observed and detected.

While not shown, an image sensor may view or observe the electromagnetic signals 402 to facilitate summing the underlying values 412. For instance, the image sensor may be configured to one or more of isolate, focus on, or otherwise observe one or more regions of interest 410. The regions of interest 410 may represent a configuration or capability for the image sensor to view, detect, or measure at a discrete, isolated portion of a display. For example, while the image sensor may be capable of seeing or sensing an entire display (or multiple displays), the region of interest may focus on one discrete portion of the display (e.g., less than all of the display). In some examples, the regions of interest 410 may correspond to a specific property of electromagnetic energy that the image sensor is configured to detect, such as a color or polarization. In some cases, the regions of interest 410 may be discrete, isolated regions which each focus specifically on one entry in an electromagnetic signal 402. For example, for an electromagnetic signal having 10 entries, the image sensor may be configured with 10 regions of interest to focus specifically on those 10 entries, one at a time. In this way, the image sensor may be capable of detecting just the light intensity at a specific entry of an electromagnetic sensor. For instance, at least a portion a given electromagnetic signal 402 may be located outside of one or more of the corresponding regions of interest. For example, a region of interest may correspond with a specific entry of an electromagnetic signal, such as an entry associated with 10^{th} integer index position or other, and the other entries of the electromagnetic signal may be located outside of that particular region of interest.

In some cases, each of the electromagnetic signals 402 may have a same shape, form, number of entries, order, arrangement, etc., and sets (collectively 414) of regions of interest may correspond with regions of interest 410 at a same spot or location of the associated electromagnetic signal. For example, the sets 414 of regions of interest may each correspond with a first or top entry, a second entry, a last or bottom entry, etc., of the corresponding electromagnetic signals. In some cases, the regions of interest 410 within a set 414 may not necessarily each be at the same location or position of a given electromagnetic signal. For example, a set 414 of regions of interest corresponding with a given index position may include a region of interest for the first electromagnetic signal 402-1 that is a top or first entry, and a region of interest for the second electromagnetic signal 402-2 may correspond with an entry that is at a different position in the pattern but nevertheless corresponds with the same index position and/or bit in the encoding scheme. In some cases, one or more electromagnetic signals may have a different shape, form, pattern, or order, and the regions of interest 410 may nevertheless be organized into sets 414 of regions of interest each associated with a given index position wherever the individual entries may be located within their respective electromagnetic signals. In this way, electromagnetic signals of any of a variety of shapes, orders, patterns, or forms, may be implemented in connection with one or more of the techniques described herein.

Accordingly, the image sensor may be configured for or capable of implementing various regions of interest across multiple different electromagnetic signals 402, including across electromagnetic signals displayed on different displays. For example, the image sensor may be configured to observe regions of interest for each of the entries of the first electromagnetic signal 402-1 displayed on a first display and may also be configured to observe regions of interest for each of the entries of the second electromagnetic signal 402-2 displayed on a second display. Indeed, the image sensor may implement regions of interest for any number of electromagnetic signals displayed at any number of displays, including different types of displays. In some cases, one or more electromagnetic signals may be displayed having corresponding regions of interest that are used for the purpose of normalizing across displays.

The image sensor may leverage the regions of interest to perform summation of the values 412, similar to that described in connection with FIG. 3. For example, the image sensor may scan across various sets of regions of interest, each of which may correspond to an index position of the encoding scheme. For instance, the example process 400 illustrates a first set 414-1 of regions of interest, a second set 414-2 of regions of interest, and so on to a zth set 414-z of regions of interest. The number of regions of interest may correspond with the number of entries (e.g., bits) in the encoding scheme.

When scanning across a set of regions of interest, the image sensor may count or tally the displayed entries for the corresponding index position. For instance, in the example shown, the first set 414-1 of regions of interest may correspond with a 10^{th} integer index position (or other index position) having a multiplication factor of 2⁹. When scanning, viewing, detecting, or observing each of the regions of interest 410 in the first set 414-1 of regions of interest, the image sensor may tally or increase the count by 1 for each entry it detects having a high, on, 1, or activated entry (e.g., a high light intensity), and may not tally or increase the count for each entry it detects as having a low, off, 0, or deactivated entry (e.g., low light intensity). For instance, the count for the 3 regions of interest 410 shown in the first set 414-1 of regions of interest is shown as 3, illustrating 3 regions of interest 410 in the set having an associated entry of a high light intensity. Similarly, the second set 414-2 of regions of interest may have a count of 1, indicating only 1 region of interest 410 having an associated entry of a high light intensity. The image sensor may continue in this manner scanning the various sets of regions of interest until the zth st 414-z of regions of interest. In this way, the image sensor may determine, for each of the index locations of the encoding scheme, a count or tally. The image sensor may utilize the counts and the associated multiplication factors to determine a sum value 452 which may be an approximation, estimate, or calculation of the sum of the first values 412-1, the second value 412-2, and so on to the ith value 412-i.

In this way, the image sensor, based on entry-wise detection of the entries of the electromagnetic signals, may determine the sum total (or an estimate thereof) of the underlying activation values of the electromagnetic signals. While the process 400 may nevertheless involve the image sensor (e.g., in particular an inline processor such as an FPGA) storing and accessing memory resources in order to tally the counts and ultimately determine the sum value 452, this may nevertheless represent a significant savings to the computation and transmission of data between AI layers. For example, tallying a running total of the counts for each index position may require very little memory access, which may pale in comparison to traditional methods of storing and recalling, in mass, each weighted activation and summing of the same. Additionally, the application of the multiplication factors and ultimate summation of the sum value 452, while computations that a processor performs, are few compared to the brute force summation computations of hundreds, thousands, or millions of weighted activations per layer, as are typically performed by processors in traditional AI model solutions. Indeed, because the image sensor (or other processor) is not performing an actual computation on the underlying weighted activations (e.g., summing the underlying values in the typical sense), but rather is only tallying the detecting light intensity at each region of interest, applying a multiplication factor, and summing the (e.g., 16) results, the process 400 may realistically be scaled to include any number of electromagnetic signals 402, or more particularly, the process 400 may facilitate AI models having any number of parameters/neurons at each layer. Indeed, in traditional AI model solutions, there may be a practical limit to the number of nodes that can be processed for each layer, as increasing the number of computations to be performed at each layer may become prohibitively computationally expensive.

Further, the process 400 may also facilitate consolidating the amount of information to be transmitted between layers of an AI model. For instance, because the process 400 determines the sum value 452, this value may be transmitted to a given receiving node of the next layer, and it may not be necessary to communicate any of the underlying weighted activations to that receiving node. In this way, a single sum value may be determined and transmitted to each receiving node, for example, rather that the mass serialization and transmission of all of the weighted activation data for all of the nodes of the sending layer, and the storing of those transmitted weighted activations in memory by the receiving node. The consolidation of data in this way further highlights the efficiency gains that the present techniques provide over bottlenecks that traditional AI systems face.

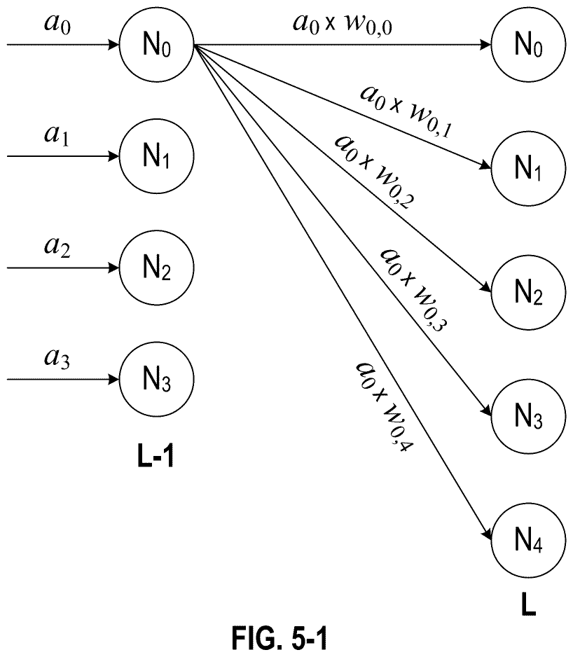

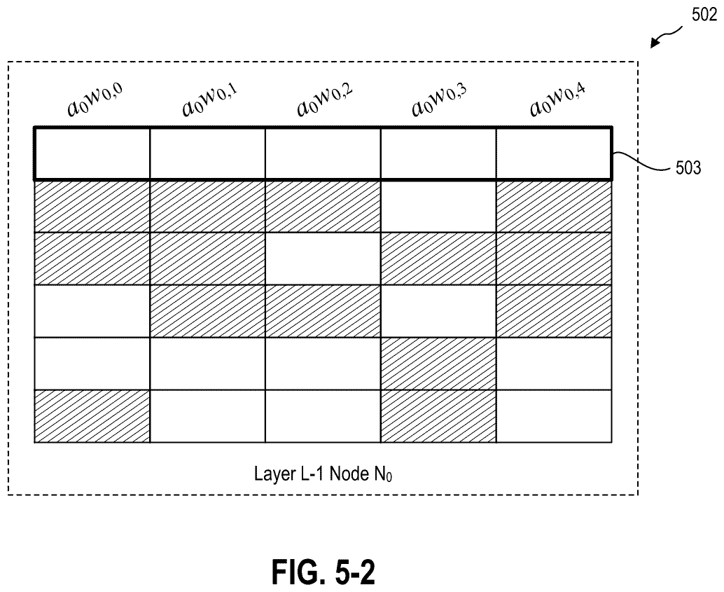

FIG. 5-1 illustrates an example of various nodes N of a layer L-1 and various nodes N of a layer L, and connections therebetween, according to at least one embodiment of the present disclosure. FIG. 5-2 illustrates an electromagnetic signal representing various weighted activations in relation to the architecture of FIG. 5-1, according to at least one embodiment of the present disclosure.

With reference to FIG. 5-1, in this example, the layer L-1 includes nodes N₀, N₁, N₂, and N₃, and the layer L includes nodes N₀, N₁, N₂, N₃, and N₄. The layers L-1 and L may be layers of an AI model which may include any number, and often many (e.g., thousands, millions, or billions) of nodes, but for simplicity and illustrative purposes, a select few nodes are shown and described.

Each node N of the layer L-1 may receive or may be associated with an activation a, such as based on information received from a previous layer (e.g., layer L-2). In some cases, each activation a may be determined based on an activation function as described herein, including a sum of a collection of several weighted activations, such as a sum of a weighted activation from each node of the previous layer, and a bias applied thereto. The layer L-1 may perform various computations on the activations a as described herein, such as to produce weighted activations for each node N to transmit to the nodes N of the layer L. Typically, the nodes N of each layer are connected to each of the nodes N of the next layer in an all-to-all network configuration. Accordingly, each node N of the layer L-1 is connected to each node N of the layer L. The connections between the node No of layer L-1 and each of the nodes N₀-N₄ of the layer L are shown in FIG. 3-1 for simplicity, but it should be understood that similar connections exist for each of the nodes N₁-N₃ of the layer L-1.

Each of the connections of the node N₀ may correspond to a weight w. For example, while the activation do may be the same for the node N₀, depending on the receiving node, the activation do may be weighted by a unique weight w corresponding to the receiving node N. For instance, a weight w_{0,0} may correspond to the connection between the node N₀ of the layer L-1 and the node No of the layer L. Similarly, weights w_{0,1}; w_{0,2}; w_{0,3}; and w_{0,4} may correspond to the connections to the nodes N₁-N₄, respectively, of the layer L. In this way, each node may correspond with a single activation a, but may compute and transmit many weighted activations equal to the number of nodes in the receiving layer. For instance, the layer L-1 having 4 nodes and the layer L having 5 nodes may result in 20 weighted activations to compute at layer L-1 and transmit to the nodes of layer L. This all-to-all network configuration of the nodes N further highlights the sheer volume of data to be processed at each layer, which can result in bottleneck issues in conventional AI model systems, as discussed herein.

With reference to FIG. 5-2, the electromagnetic signal 502 may be utilized in accordance with the techniques described herein for summing weighted activations across multiple nodes, and transmitting a sum value to a receiving node. In this example, the electromagnetic signal 502 may include several sections, patterns, or constituent electromagnetic signals. For instance, the electromagnetic signal 502 may be an electromagnetic signal associated with or displayed by the node No of layer L-1, and according includes 5 columns corresponding to the 5 weighted activations a₀w_{0,0}, a₀w_{0,1} a₀w_{0,2} a₀w_{0,3} and a₀w_{0,4} associated with the connection of the node No of Layer L-1 with each of nodes N₀-N₄ of layer L. For instance, each of the weighted activations may be encoded as a column of entries via the encoding scheme as described in connection with FIG. 3, which columns may be combined or located adjacent to form the electromagnetic signal 502. As mentioned, the encoding of values to electromagnetic signal is not limited to columns, but rather, may be any shape, pattern, or form and accordingly the weighted activations may be encoded in any configuration and combined to form the electromagnetic signal 502 having any shape or form.

In some cases, the electromagnetic signal 502 may include a header 503 which may present various information. For example, the header 503 may be encoded via a pattern of entries with light intensity in a similar manner to that described herein. The header 503 may indicate reference information, such as a sending node, one or more receiving nodes, references for calibration of an image sensor, references for positioning, location, or orientation of the constituent electromagnetic signals, synchronization information, or other information and combinations thereof. While illustrated here as a single row, in some cases the header 503 may comprise multiple rows, may be a column, or may have one or more entries that are otherwise located, such as at a perimeter, corner, or elsewhere in the overall pattern of the electromagnetic signal 502. In this way, the electromagnetic signal 502 may present, for a given node, each of the weighted activations associated with the node's connection to nodes of the next layer. For instance, each node of a sending layer (layer L-1) may generate and display, in a similar manner, an electromagnetic signal for representing their associated weighted activations.

FIGS. 6-1 through 6-4 illustrate an example of a system 600 performing a collective operation using electromagnetic signals, according to at least one embodiment of the present disclosure. As shown, a Layer L-1 may include nodes N0, N1, N2, N3, N4, and N5. The layer L-1 and the various nodes N0-N1 may be one or more of hosted, operated, or processed by a processing unit 620 and/or associated memory 622 (or multiple processing units and multiple memories). The processing unit 620 and memory 622 may be any of the processing units and memories as described herein, such as a GPU and VRAM.

Each node N0-N5 may generate (e.g., via the processing unit 620) an electromagnetic signal (collectively 602) for displaying on one or more displays as described herein. For instance, the node N0 may generate and display an electromagnetic signal 602-0, the node N1 may generate and display an electromagnetic signal 602-1, the node N2 may generate and display and electromagnetic signal 602-2, the node N3 may generate and display an electromagnetic signal 602-3, the node N4 may generate and display an electromagnetic signal 602-4, and the node N5 may generate and display an electromagnetic signal 602-5. The electromagnetic signals may be electromagnetic signals similar to that shown and described in connection with FIG. 5-2 and may be displayed for representing each of the weighted activations for the associated node (e.g., weighted activations for connections of the associated node with nodes of the next layer L).

The system 600 includes an image sensor 634, which may include or may be associated with a processing unit 630 and memory 632, for example, in line with the image sensor 634. In this example, the image sensor 634 may be configured to view and/or observe each of the electromagnetic signals 602. For instance, the electromagnetic signals 602 may be displayed on one or more displays 605. The displays 605 may be positioned near or adjacent one another, or may be otherwise located, such as at discrete locations of a room or space. The image sensor 634 may view one or more of the displays 605 based on a viewing angle of the image sensor 634 and/or the image sensor 634 may be configured with a gimbal or other mechanism for adjusting the field of view.

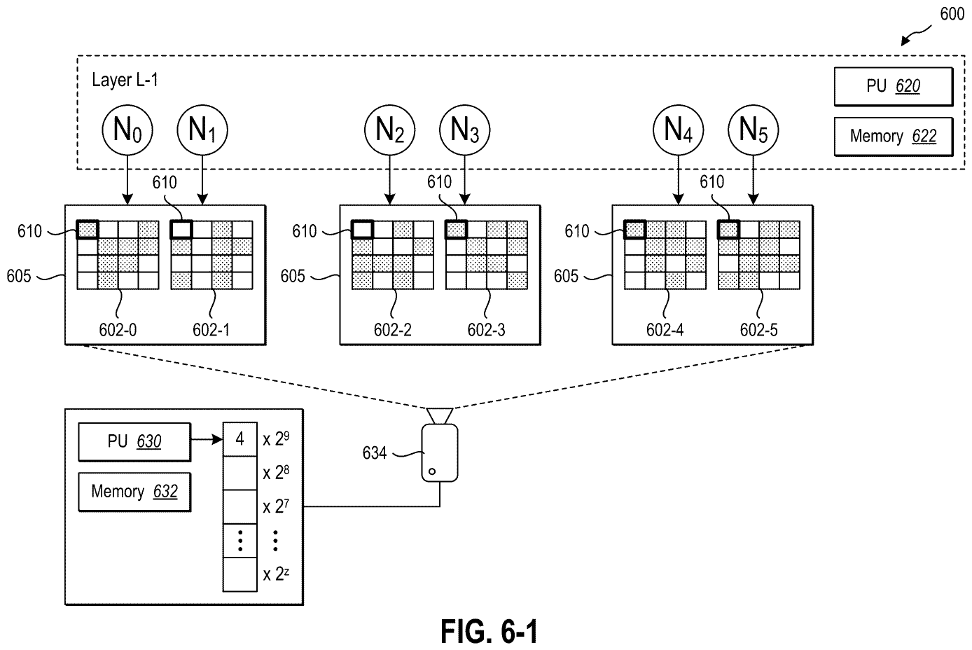

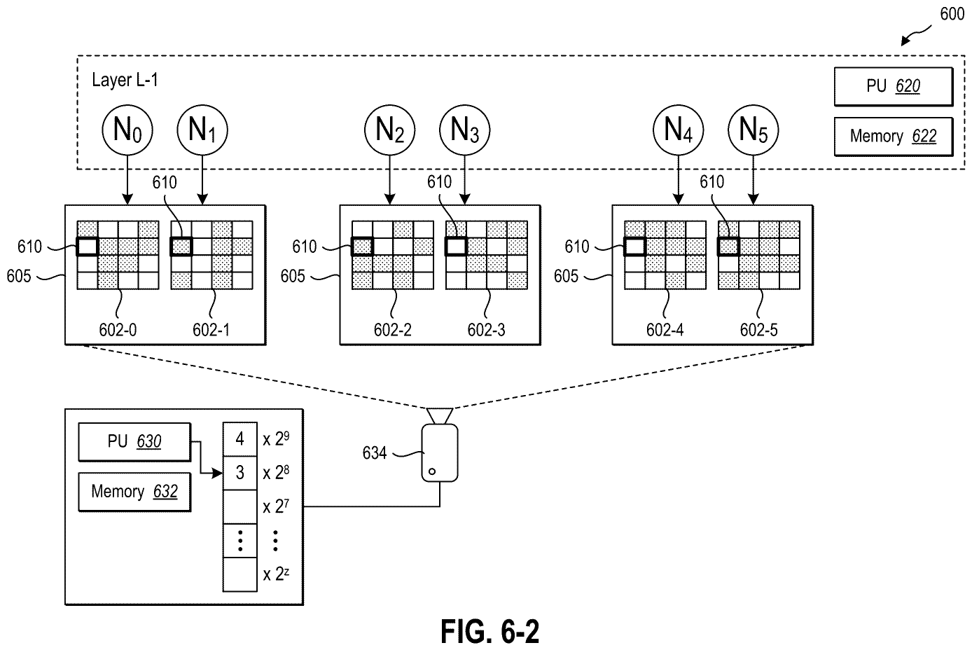

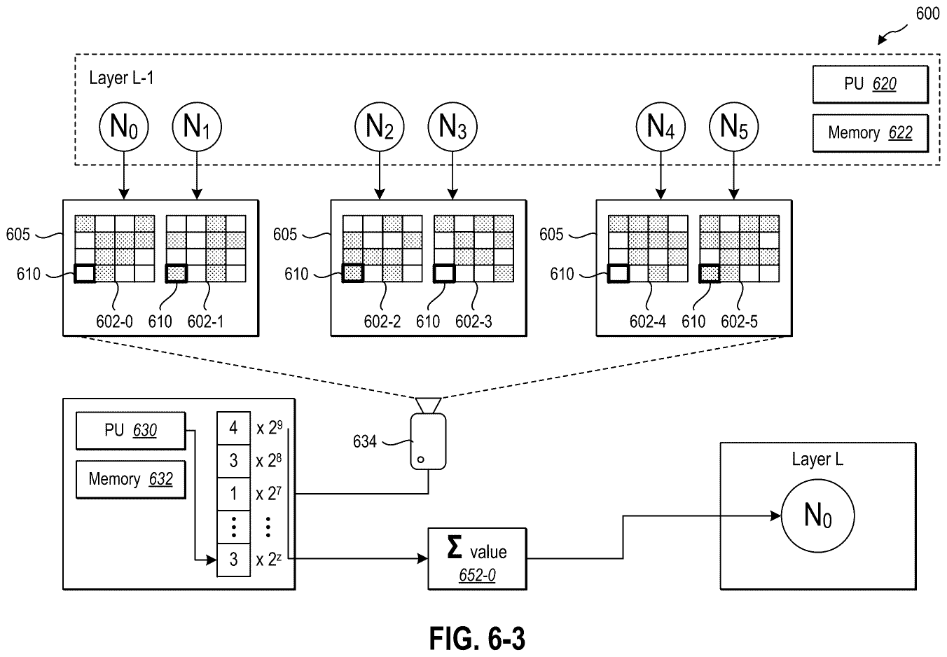

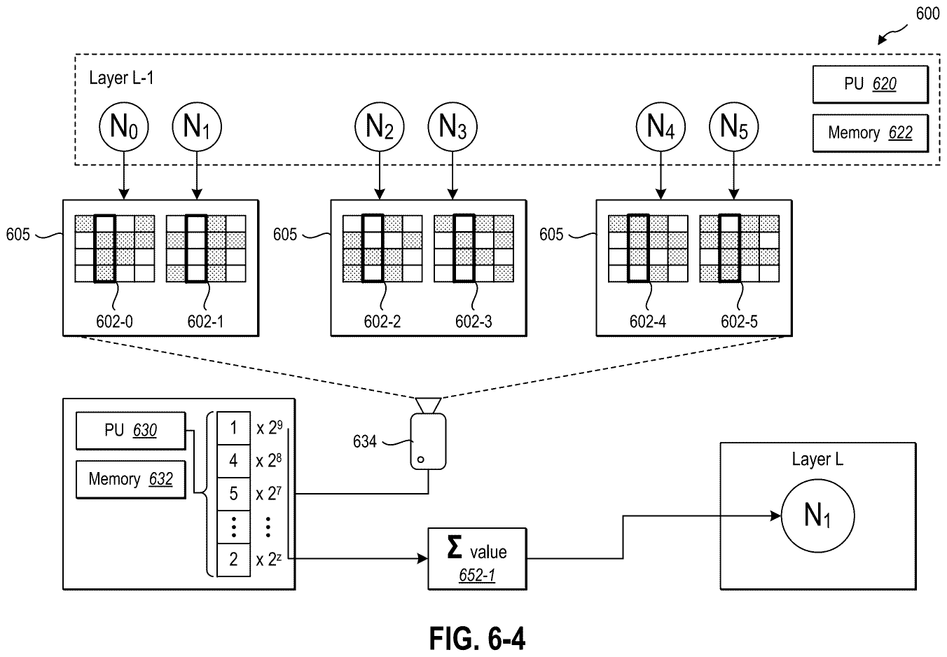

The image sensor 634 may observe the electromagnetic signals 602 for summing the weighted activations encoded therein, similar to one or more embodiments described herein. For example, the image sensor 634 may be configured to one or more of focus on, detect, observe, or measure at various regions of interest 610. For instance, the regions of interest may correspond with a specific entry of each of the electromagnetic signals, such as corresponding to a specific index position of an encoding scheme by which the electromagnetic signals 602 are encoded. The image sensor 634 may scan through (e.g., view each of in turn) a set of regions of interest which may all be associated and may determine a count or tally for the set. For instance, in this example of FIG. 6-1, the image sensor 634 determines the count to be 4, indicating that at 4 of the regions of interest, the associated entry exhibited a high, on, or 1 value for the associated entry. Thus, the image sensor 634 may determine that for the associated index position (e.g., a tenth integer index position) the count is 4. As shown, this index position may correspond with a multiplication factor of 2⁹.

After determining the count for the index position, the image sensor may proceed to a next set of regions of interest. As shown in FIG. 6-2, a set of regions of interest 610 may correspond with a next entry in the associated electromagnetic signals 602. The image sensor may scan through each of the regions of interest 610 of this set and may determine the count of the associated entries to be 3. Accordingly, the image sensor 634 may populate the count of 3 for the associated index position, which may correspond with a multiplication factor of 2⁸.

As shown in FIG. 6-3, the image sensor 634 may continue in this manner through various sets of regions of interest 610 until each (all in some embodiments) of the entries of index positions is populated. For instance, in some cases the encoding scheme includes 16 index positions, or any other quantity of index positions may be utilized in connection with any other encoding scheme. The image sensor 634 may then apply the associated multiplication factors and sum the results to generate a sum value 652-0. For instance, the sum value 652-0 may be a sum of the weighted activations from each of the nodes N0-N5 of layer L-1 as connected to a node N0 of layer L. The image sensor 634 may then transmit the sum value 652-0 to the layer L (e.g., to the node N0 of layer L). In this way, the system 600 may facilitate collecting and summing each of the relevant weighted activations for node N0 of layer L, and transmitting just the sum value 652-0 to the layer L. For instance, the collective operation (e.g., sum) in this case may be performed without transmitting the underlying weighted activations to the layer L. Additionally, the collective operation may be performed without a processor having actually performed a conventional sum computation on each of the weighted activation, but rather, the sum value 652-0 may be determined (e.g., estimated) based on tallying or counting the light intensities as the various regions of interest as described.

As shown in FIG. 6-4, the image sensor 634 may proceed in a similar manner with respect to a next weighted activation of each of the electromagnetic signals. For example, the image sensor 634 may proceed to scan through sets of regions of interest for a next column of each of the electromagnetic signals, which may represent or communicate a weighted activation for each of the nodes N-N5 of the layer L-1 in connection with a node N1 of the layer L. Based on determining a count for each index location, applying the multiplication factors, and summing the results, the image sensor 634 may determine a sum value 652-1, which may be a sum of all the weighted activations as applicable to the node N1 of the layer L. Accordingly, the image sensor 634 may transmit the sum value 652-1 to the layer L (e.g., to the node N1). In this way, the image sensor 634 may proceed through each of the entries of the electromagnetic signals in order to determine sums of each of the sets of weighted activations that apply to a given receiving node of the layer L. For example, in this example each of the electromagnetic signals may have 4 columns for communicating 4 weighted activations, which may correspond with Layer L comprising 4 nodes. Accordingly, the image sensor 634 may determine 4 distinct sum values and may transmit those sum values to the layer L for the respective receiving nodes. As a simple example then, the 4 weighted activations for each of the 6 nodes N0-N5 of the layer L-1, totaling 20 activations, may be consolidated to 4 sum values for transmitting to the layer L, highlighting the efficiency gains by the system 600. Indeed, when considered at the scale of thousands to millions of nodes per layer, the consolidation of data to be transmitted in this way is significant and may facilitate reducing the latency associated with AI model operation.

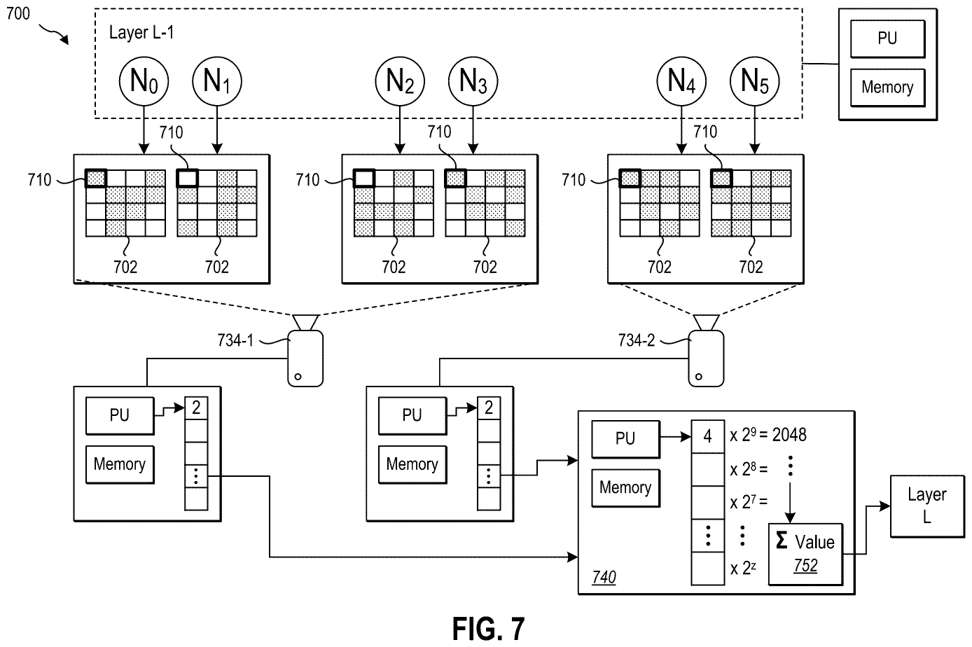

FIG. 7 illustrates another example of a system 700 for performing a collective operation using electromagnetic signals, according to at least one embodiment of the present disclosure. As shown, the system 700 may include a first image sensor 734-1 and a second image sensor 734-2, each having an associated processing unit and memory. The nodes N0-N5 of layer L-1 may be substantially similar to those shown and described in connection with FIGS. 6-1 to 6-4. For instance, each of the nodes N0-N5 may generate and present an electromagnetic signal 702 for communicating associated weighted activations as described herein.

In some cases, the first image sensor 734-1 may view or observe a first portion of the electromagnetic signals 602 and the second image sensor 734-2 may view a second (e.g., remaining) portion of the electromagnetic signals. These two image sensors are intended to be illustrative of the system 700 including any number of image sensors. For example, the system 700 may include many image sensors for viewing the various electromagnetic signals. For instance, as described herein, the techniques of leveraging electromagnetic signals for collective operations may be scaled to include any number of electromagnetic signals (which may be limited by an electromagnetic signal saturation point—e.g., an optical saturation point) and for enabling the implementation of any number of nodes at each layer of an AI model. Accordingly, in some cases the electromagnetic signals may be too numerous for one image sensor to capture, and multiple image sensors may be utilized, together in conjunction with an aggregator processing unit 740, for generating sum values of associated sets of weighted activations and transmitting those sum values to the layer L.

In this example, the first image sensor 734-1 may observe the electromagnetic signals 702 displayed in association with nodes N0-N3, and the second image sensor 734-2 may observe the electromagnetic signals 702 displayed in association with nodes N4-N5. In a similar manner to that described above in connection with FIGS. 6-1 to 6-4, each of the image sensors may implement various sets of regions of interest 710 and may count or tally the associated entries of the electromagnetic signals to determine a count for each index position of the underlying encoding scheme. For instance, as shown, the first image sensor 734-1 determines a count of 2 across its 4 associated electromagnetic sensors for the given index positions, and the second image sensor 734-2 determines a count of 2 across its 2 associated electromagnetic sensors for the same index position. Each of the image sensors may transmit their count to the aggregator processing unit which may aggregate the counts and determine a total count of 4 for the index position. The system 700 may proceed in this manner to determine each of the counts for each of the index positions and the aggregator processing unit 740 may accordingly determine a sum value 752 and transmit the sum value 752 to the layer L (e.g., to the associated receiving node). Further, the system 700 may proceed through each of the weighted activations (e.g., columns) of the electromagnetic signals 702 and may determine a corresponding sum value 752 for transmitting to the respective nodes of the layer L. In this way, the system 700 may facilitate scaling the collecting operation techniques to include any number of electromagnetic signals and/or any number of nodes at each layer.

In some cases, the system 700 (or any of the systems as described herein) may implement one or more synchronization techniques to ensure that each node is presenting and/or updating its corresponding electromagnetic signal in synchrony with the other nodes. Additionally, the synchronization may ensure that the image sensors are scanning and/or detecting the sets of regions of interest (e.g., determining the counts for the same index position and for the same end sum value) in synchrony. In some cases, the displays by which the nodes display their electromagnetic signals may be synchronized. In other cases, the image sensors may be synchronized (e.g., using approximately the same timing) with the displays. Synchronization may ensure that operations are executed in the correct order and/or may prevent data corruption or inaccuracies.

In some cases, the various processors of the system 700 may send signals and/or communicate with one another to ensure that each processor is operating at a same stage and/or has completed their work for a stage before any one processor moves onto a next task or stage. For instance, the processors may be synchronized such that each processor displays (in the case of the nodes) or detects (in the case of the image sensors) related information. In the case of the system 700 specifically, the aggregator processing unit may indicate to the image sensors when to proceed with determining a next count, when to proceed with a next set of regions of interest, when to proceed with a next weighted activation, etc. For instance, the aggregator processor may include a display (e.g., projector) for displaying information that the image sensors may view or reference for instructing the sequence of operations for the image sensors, as determined by the aggregator processing unit 740.

In some cases, the aggregator processing unit 740 instructs the image sensors in this way by accounting for an acceptable or threshold amount of error. For instance, in some cases, a threshold amount of data from the sending nodes may be sufficient for determining a sum value and transmitting the sum value to the next layer, and rather than waiting for a (e.g., slow) processor, node, or display to participate, the aggregator processor may instruct the image sensors and/or displays to proceed with a next operation when a threshold amount of data has been received by the aggregator processor (e.g., a count reported by the image sensors corresponding with a threshold amount of nodes reporting).

In some cases, one or more of the image sensors as described herein (e.g., in any of the embodiments) may be representative of a feed or image as generated from two or more image sensors, but which has been stitched or aggregated to produce a composite image for evaluating regions of interest by a (e.g., single) processing unit. In this way, large displays or large areas of multiple displays may be utilized to display a considerable number of electromagnetic signals, which may be viewed by multiple image sensors and stitched together for analyzing via the various regions of interest as described herein.

In some cases (in any of the embodiments described herein), when transmitting a sum value from a processing unit (e.g., of an image sensor or an aggregator processing unit) to a next layer or receiving node, the sum value may be transmitted electronically. For example, the sum value may be transmitted via hardwired connection, wireless connection, fiber optic connection, or other connection. In some cases, the sum value may be transmitted through the use of electromagnetic signals as described herein. For example, the decimal number of the sum value may be encoded into an electromagnetic signal using one or more of the encoding schemes as described herein, one or more other encoding schemes, or combinations thereof. The receiving layer or receiving node may be equipped with an image sensor for detecting and/or measuring the encoded electromagnetic signal and in this way may receive the sum value.

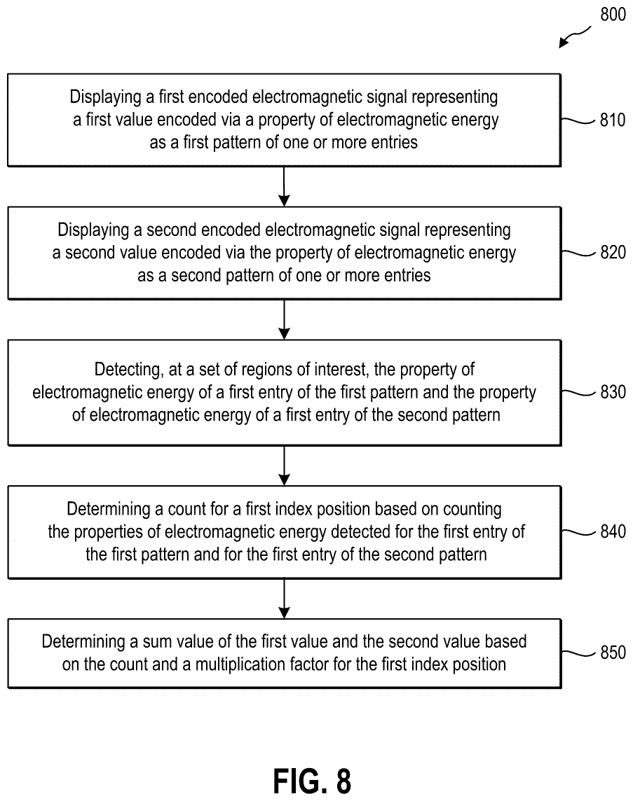

FIG. 8 illustrates a flow diagram for a method 800 or a series of acts for performing a collective operation using electromagnetic energy, according to at least one embodiment of the present disclosure. While FIG. 8 illustrates acts according to one embodiment, alternative embodiments may add to, omit, reorder, or modify any of the acts of FIG. 8.

In some embodiments, the method 800 includes an act 810 of displaying a first encoded electromagnetic signal representing a first value encoded via a property of electromagnetic energy as a first pattern of one or more entries.

In some embodiments, the method 800 includes an act 820 of displaying a second encoded electromagnetic signal representing a second value encoded via the property of electromagnetic energy as a second pattern of one or more entries.

In some embodiments, the method 800 includes an act 830 of detecting, at a set of regions of interest, the property of electromagnetic energy of a first entry of the first pattern and the property of electromagnetic energy of a first entry of the second pattern.

In some embodiments, the method 800 includes an act 840 of determining a count for a first index position based on counting the properties of electromagnetic energy detected for the first entry of the first pattern and for the first entry of the second pattern.

In some embodiments, the method 800 includes an act 850 of determining a sum value of the first value and the second value based on the count and a multiplication factor for the first index position.

In some embodiments, the property of electromagnetic energy is a light intensity or a wavelength of electromagnetic energy. In some embodiments, the multiplication factor is a binary exponential multiplication factor.

In some embodiments, the first encoded electromagnetic signal and the second encoded electromagnetic signal each encode patterns as fixed-point binary bit patterns having a fixed number of integer bits and a fixed number of fractional bits. In some embodiments, the first index position corresponds with an index position of the first entry of the first pattern and of the first entry of the second pattern.

In some embodiments, the method 800 further includes displaying the first encoded electromagnetic signal at a discrete location from the second encoded electromagnetic signal without collocating the first encoded electromagnetic signal with the second encoded electromagnetic signal.

In some embodiments, the method 800 further includes displaying a third encoded electromagnetic signal representing a third value encoded via the property of electromagnetic energy as a third pattern of one or more entries, and displaying a fourth encoded electromagnetic signal representing a fourth value encoded via the property of electromagnetic energy as a fourth pattern of one or more entries. In some embodiments, the method 800 further includes generating the first encoded electromagnetic signal based on collocating the third and fourth encoded electromagnetic signals, wherein the collocating causes the property of electromagnetic energy at the one or more entries of the third pattern and of the fourth pattern to sum such that the first value represented by the first encoded electromagnetic signal is a sum of the third value and the fourth value.

In some embodiments, the method 800 further includes determining the sum value without performing a sum computation with a processing unit on the first value and the second value. In some embodiments, the method 800 further includes determining the sum value without transmitting the first and second values from one or more processing units to a receiving processing unit to perform a sum computation on the first and second values with the receiving processing unit.

In some embodiments, the method 800 includes, for each node of a plurality of nodes of a layer of an artificial intelligence (AI) model: determining a weighted activation for the node, generating an encoded electromagnetic signal representing the weighted activation via a property of electromagnetic energy as a pattern of a set of entries, and displaying the encoded electromagnetic signal on one or more displays. The method 800 may further include detecting, at a plurality of sets of regions of interest, the property of electromagnetic energy of each entry of the encoded electromagnetic signals for the plurality of nodes, wherein each set of regions of interest corresponds to an index position of the patterns of each of the electromagnetic signals, and determining, for each index position, a count based on counting the properties of electromagnetic energy detected at the associated set of regions of interest. In some embodiments, the method 800 includes determining a sum value of the values represented by the encoded electromagnetic signals of the plurality of nodes based on the count and a multiplication factor for each index position and communicating the sum value to a receiving node of a receiving layer of the AI model. In some embodiments, the sum value may be communicated to the receiving node without communicating the weighted activations for the plurality of nodes to the receiving node.

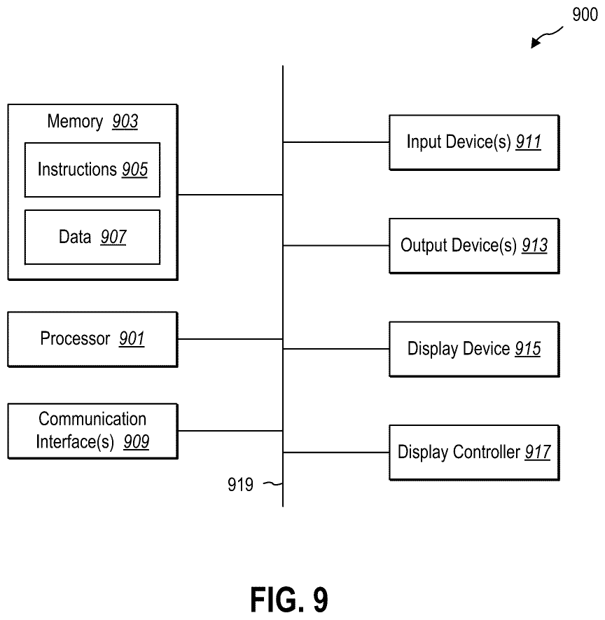

Turning now to FIG. 9, this figure illustrates certain components that may be included within a computer system 900. One or more computer systems 900 may be used to implement the various devices, components, and systems described herein.

The computer system 900 includes a processor 901. The processor 901 may be a general-purpose single- or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 901 may be referred to as a central processing unit (CPU). Although just a single processor 901 is shown in the computer system 900 of FIG. 9, in an alternative configuration, a combination of processors (e.g., an ARM and DSP) could be used.

The computer system 900 also includes memory 903 in electronic communication with the processor 901. The memory 903 may include computer-readable storage media and can be any available media that can be accessed by a general purpose or special purpose computer system. Computer-readable media that store computer-executable instructions are non-transitory computer-readable media (device). Computer-readable media that carry computer-executable instructions are transmission media. Thus, by way of example and not limitations, embodiment of the present disclosure can comprise at least two distinctly different kinds of computer-readable media: non-transitory computer-readable media (devices) and transmission media.

Both non-transitory computer-readable media (devices) and transmission media may be used temporarily to store or carry software instructions in the form of computer readable program code that allows performance of embodiments of the present disclosure. Non-transitory computer-readable media may further be used to persistently or permanently store such software instructions. Examples of non-transitory computer-readable storage media include physical memory (e.g., RAM, ROM, EPROM, EEPROM, etc.), optical disk storage (e.g., CD, DVD, HDDVD, Blu-ray, etc.), storage devices (e.g., magnetic disk storage, tape storage, diskette, etc.), flash or other solid-state storage or memory, or any other non-transmission medium which can be used to store program code in the form of computer-executable instructions or data structures and which can be accessed by a general purpose or special purpose computer, whether such program code is stored or in software, hardware, firmware, or combinations thereof.

Instructions 905 and data 907 may be stored in the memory 903. The instructions 905 may be executable by the processor 901 to implement some or all of the functionality disclosed herein. Executing the instructions 905 may involve the use of the data 907 that is stored in the memory 903. Any of the various examples of modules and components described herein may be implemented, partially or wholly, as instructions 905 stored in memory 903 and executed by the processor 901. Any of the various examples of data described herein may be among the data 907 that is stored in memory 903 and used during execution of the instructions 905 by the processor 901.

A computer system 900 may also include one or more communication interfaces 909 for communicating with other electronic devices. The communication interface(s) 909 may be based on wired communication technology, wireless communication technology, or both. Some examples of communication interfaces 909 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

The communication interfaces 909 may connect the computer system 900 to a network. A “network” or “communications network” may generally be defined as one or more data links that enable the transport of electronic data between computer systems and/or modules, engines, or other electronic devices, or combinations thereof. When information is transferred or provided over a communication network or another communications connection (either hardwired, wireless, or a combination of hardwired or wireless) to a computing device, the computing device properly views the connection as a transmission medium. Transmission media can include a communication network and/or data links, carrier waves, wireless signals, and the like, which can be used to carry desired program or template code means or instructions in the form of computer-executable instruction or data structures and which can be accessed by a general purpose or special purpose computer.

A computer system 900 may also include one or more input devices 911 and one or more output devices 913. Some examples of input devices 911 include a keyboard, mouse, microphone, remote control device, button, joystick, trackball, touchpad, and lightpen. Some examples of output devices 913 include a speaker and a printer. One specific type of output device that is typically included in a computer system 900 is a display device 915. Display devices 915 used with embodiments disclosed herein may utilize any suitable image projection technology, such as liquid crystal display (LCD), light-emitting diode (LED), gas plasma, electroluminescence, or the like. A display controller 917 may also be provided, for converting data 907 stored in the memory 903 into one or more of text, graphics, or moving images (as appropriate) shown on the display device 915.

The various components of the computer system 900 may be coupled together by one or more buses, which may include one or more of a power bus, a control signal bus, a status signal bus, a data bus, other similar components, or combinations thereof. For the sake of clarity, the various buses are illustrated in FIG. 9 as a bus system 919.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various embodiments.

Further, upon reaching various computer system components, program code in the form of computer-executable instructions or data structures can be transferred automatically or manually from transmission media to non-transitory computer-readable storage media (or vice versa). For example, computer executable instructions or data structures received over a network or data link can be buffered in memory (e.g., RAM) within a network interface module (NIC), and then eventually transferred to computer system RAM and/or to less volatile non-transitory computer-readable storage media at a computer system. Thus, it should be understood that non-transitory computer-readable storage media can be included in computer system components that also (or even primarily) utilize transmission media.

### INDUSTRIAL APPLICABILITY

The following description from ¶¶ [0093]-[0112] includes various embodiments that, where feasible, may be combined in any permutation. For example, the embodiment of paragraph [0093] may be combined with any or all embodiments of the following paragraphs. Embodiments that describe acts of a method may be combined with embodiments that describe, for example, systems and/or devices. Any permutation of the following paragraphs is considered to be hereby disclosed for the purposes of providing “unambiguously derivable support” for any claim amendment based on the following paragraphs. Furthermore, the following paragraphs provide support such that any combination of the following paragraphs would not create an “intermediate generalization.”

In some embodiments, a method of performing a collective operation using electromagnetic energy includes displaying a first encoded electromagnetic signal representing a first value encoded via a property of electromagnetic energy as a first pattern of one or more entries, displaying a second encoded electromagnetic signal representing a second value encoded via the property of electromagnetic energy as a second pattern of one or more entries, detecting, at a set of regions of interest, the property of electromagnetic energy of a first entry of the first pattern and the property of electromagnetic energy of a first entry of the second pattern, determining a count for a first index position based on counting the properties of electromagnetic energy detected for the first entry of the first pattern and for the first entry of the second pattern, and determining a sum value of the first value and the second value based on the count and a multiplication factor for the first index position.

In some embodiments, the property of electromagnetic energy is a light intensity or a wavelength of electromagnetic energy.

In some embodiments, the first index position corresponds with an index position of the first entry of the first pattern and of the first entry of the second pattern.

In some embodiments, the multiplication factor is a binary exponential multiplication factor.

In some embodiments, the first encoded electromagnetic signal and the second encoded electromagnetic signal each encode patterns as fixed-point binary bit patterns having a fixed number of integer bits and a fixed number of fractional bits.

In some embodiments, the method further includes displaying the first encoded electromagnetic signal at a discrete location from the second encoded electromagnetic signal without collocating the first encoded electromagnetic signal with the second encoded electromagnetic signal.

In some embodiments, the method further includes displaying a third encoded electromagnetic signal representing a third value encoded via the property of electromagnetic energy as a third pattern of one or more entries, displaying a fourth encoded electromagnetic signal representing a fourth value encoded via the property of electromagnetic energy as a fourth pattern of one or more entries, and generating the first encoded electromagnetic signal based on collocating the third and fourth encoded electromagnetic signals, wherein the collocating causes the property of electromagnetic energy at the one or more entries of the third pattern and of the fourth pattern to sum such that the first value represented by the first encoded electromagnetic signal is a sum of the third value and the fourth value.

In some embodiments, the method further includes determining the sum value without performing a sum computation with a processing unit on the first value and the second value.

In some embodiments, the method further includes determining the sum value without transmitting the first and second values from one or more processing units to a receiving processing unit to perform a sum computation on the first and second values with the receiving processing unit.

In some embodiments, a system includes one or more displays, an image sensor, one or more processing units, memory in electronic communication with the one or more processing units, and instructions stored in the memory, the instructions being executable by the one or more processing units to, with the one or more displays: display a first encoded electromagnetic signal representing a first value encoded via a property of electromagnetic energy as a first pattern of one or more entries, and display a second encoded electromagnetic signal representing a second value encoded via the property of electromagnetic energy as a second pattern of one or more entries, with the image sensor, detect, at a set of regions of interest on the one or more displays, the property of electromagnetic energy of a first entry of the first pattern and the property of electromagnetic energy of a first entry of the second pattern, and, with the one or more processing units: determine a count for a first index position based on counting the properties of electromagnetic energy of the first entry of the first pattern and of the first entry of the second pattern, and determine a sum value of the first value and the second value based on the count and a multiplication factor for the first index position.

In some embodiments, the one or more displays includes one or more of a projector display for projecting electromagnetic signals onto a screen, or an emitter display for displaying electromagnetic signals via one or more emitters.

In some embodiments, the one or more displays includes a first display and a second display, and further comprising displaying the first encoded electromagnetic signal on the first display and displaying the second encoded electromagnetic signal on the second display.

In some embodiments, the first display and the second display are different types of displays.

In some embodiments, the system is further configured for displaying the first encoded electromagnetic signal and the second encoded electromagnetic signal on a same display of the one or more displays.

In some embodiments, the image sensor is one or more of a camera, a photodetector, or a light sensor.

In some embodiments, the set of regions of interest includes a first region of interest at a first location on the one or more displays corresponding to the first entry of the first pattern and a second region of interest at a second location on the one or more displays corresponding to the first entry of the second pattern.

In some embodiments, at least a portion of the first encoded electromagnetic signal is displayed by the one or more displays outside of the first region of interest and at least a portion of the second encoded electromagnetic signal is displayed by the one or more displays outside of the second region of interest.

In some embodiments, the image sensor is a first image sensor and further comprising a second image sensor, and wherein the one or more processing units includes a first processing unit, a second processing unit, and an aggregator processing unit, further comprising instructions executable to, with the one or more displays: display a third encoded electromagnetic signal representing a third value encoded via the property of electromagnetic energy as a third pattern of one or more entries, and display a fourth encoded electromagnetic signal representing a fourth value encoded via the property of electromagnetic energy as a fourth pattern of one or more entries, with the second image sensor, detect, at the set of regions of interest on the one or more displays, the property of electromagnetic energy of a first entry of the third pattern and the property of electromagnetic energy of a first entry of the fourth pattern, with the first processing unit, determine a first count for the first index position based on counting the properties of electromagnetic energy of the first entry of the first pattern and of the first entry of the second pattern, with the second processing unit, determine a second count for the first index position based on counting the properties of the electromagnetic energy of the first entry of the third pattern and of a first entry of the fourth pattern, and with the aggregator processing unit: determine the count for the first index position based on summing the first and second counts received from the first and second processing units, and determine the sum value of the first value, the second value, the third value, and the fourth value based on the count and the multiplication factor for the first index position.

In some embodiments, a method of performing a collective operation using electromagnetic energy includes for each node of a plurality of nodes of a layer of an artificial intelligence (AI) model: determining a weighted activation for the node, generating an encoded electromagnetic signal representing the weighted activation via a property of electromagnetic energy as a pattern of a set of entries, and displaying the encoded electromagnetic signal on one or more displays, detecting, at a plurality of sets of regions of interest, the property of electromagnetic energy of each entry of the encoded electromagnetic signals for the plurality of nodes, wherein each set of regions of interest corresponds to an index position of the patterns of each of the electromagnetic signals, determining, for each index position, a count based on counting the properties of electromagnetic energy detected at the associated set of regions of interest, determining a sum value of the values represented by the encoded electromagnetic signals of the plurality of nodes based on the count and a multiplication factor for each index position, and communicating the sum value to a receiving node of a receiving layer of the AI model.

In some embodiments, the method further includes communicating the sum value to the receiving node without communicating the weighted activations for the plurality of nodes to the receiving node.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers' specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that is within standard manufacturing or process tolerances, or which still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements. Additionally, as used herein, the term “and/or” includes any or all combinations of one or more of the associated listed items.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method of performing a collective operation using electromagnetic energy, comprising:
displaying a first encoded electromagnetic signal representing a first value encoded via a property of electromagnetic energy as a first pattern of one or more entries;
displaying a second encoded electromagnetic signal representing a second value encoded via the property of electromagnetic energy as a second pattern of one or more entries;
detecting, at a set of regions of interest, the property of electromagnetic energy of a first entry of the first pattern and the property of electromagnetic energy of a first entry of the second pattern;
determining a count for a first index position based on counting the properties of electromagnetic energy detected for the first entry of the first pattern and for the first entry of the second pattern; and
determining a sum value of the first value and the second value based on the count and a multiplication factor for the first index position.

2. The method of claim 1, wherein the property of electromagnetic energy is a light intensity or a wavelength of electromagnetic energy.

3. The method of claim 1, wherein the first index position corresponds with an index position of the first entry of the first pattern and of the first entry of the second pattern.

4. The method of claim 1, wherein the multiplication factor is a binary exponential multiplication factor.

5. The method of claim 1, wherein the first encoded electromagnetic signal and the second encoded electromagnetic signal each encode patterns as fixed-point binary bit patterns having a fixed number of integer bits and a fixed number of fractional bits.

6. The method of claim 1, further comprising displaying the first encoded electromagnetic signal at a discrete location from the second encoded electromagnetic signal without collocating the first encoded electromagnetic signal with the second encoded electromagnetic signal.

7. The method of claim 1, further comprising:
displaying a third encoded electromagnetic signal representing a third value encoded via the property of electromagnetic energy as a third pattern of one or more entries;
displaying a fourth encoded electromagnetic signal representing a fourth value encoded via the property of electromagnetic energy as a fourth pattern of one or more entries; and
generating the first encoded electromagnetic signal based on collocating the third and fourth encoded electromagnetic signals, wherein the collocating causes the property of electromagnetic energy at the one or more entries of the third pattern and of the fourth pattern to sum such that the first value represented by the first encoded electromagnetic signal is a sum of the third value and the fourth value.

8. The method of claim 1, further comprising determining the sum value without performing a sum computation with a processing unit on the first value and the second value.

9. The method of claim 1, further comprising determining the sum value without transmitting the first and second values from one or more processing units to a receiving processing unit to perform a sum computation on the first and second values with the receiving processing unit.

10. A system, comprising:
one or more displays;
an image sensor;
one or more processing units;
memory in electronic communication with the one or more processing units; and
instructions stored in the memory, the instructions being executable by the one or more processing units to:
with the one or more displays:
display a first encoded electromagnetic signal representing a first value encoded via a property of electromagnetic energy as a first pattern of one or more entries; and
display a second encoded electromagnetic signal representing a second value encoded via the property of electromagnetic energy as a second pattern of one or more entries;
with the image sensor, detect, at a set of regions of interest on the one or more displays, the property of electromagnetic energy of a first entry of the first pattern and the property of electromagnetic energy of a first entry of the second pattern; and
with the one or more processing units:
determine a count for a first index position based on counting the properties of electromagnetic energy of the first entry of the first pattern and of the first entry of the second pattern; and
determine a sum value of the first value and the second value based on the count and a multiplication factor for the first index position.

11. The system of claim 10, wherein the one or more displays includes one or more of a projector display for projecting electromagnetic signals onto a screen, or an emitter display for displaying electromagnetic signals via one or more emitters.

12. The system of claim 10, wherein the one or more displays includes a first display and a second display, and further comprising displaying the first encoded electromagnetic signal on the first display and displaying the second encoded electromagnetic signal on the second display.

13. The system of claim 12, wherein the first display and the second display are different types of displays.

14. The system of claim 10, further comprising displaying the first encoded electromagnetic signal and the second encoded electromagnetic signal on a same display of the one or more displays.

15. The system of claim 10, wherein the image sensor is one or more of a camera, a photodetector, or a light sensor.

16. The system of claim 10, wherein the set of regions of interest includes a first region of interest at a first location on the one or more displays corresponding to the first entry of the first pattern and a second region of interest at a second location on the one or more displays corresponding to the first entry of the second pattern.

17. The system of claim 16, wherein at least a portion of the first encoded electromagnetic signal is displayed by the one or more displays outside of the first region of interest and at least a portion of the second encoded electromagnetic signal is displayed by the one or more displays outside of the second region of interest.

18. The system of claim 10, wherein the image sensor is a first image sensor and further comprising a second image sensor, and wherein the one or more processing units includes a first processing unit, a second processing unit, and an aggregator processing unit, further comprising instructions executable to:
with the one or more displays:
display a third encoded electromagnetic signal representing a third value encoded via the property of electromagnetic energy as a third pattern of one or more entries; and
display a fourth encoded electromagnetic signal representing a fourth value encoded via the property of electromagnetic energy as a fourth pattern of one or more entries;
with the second image sensor, detect, at the set of regions of interest on the one or more displays, the property of electromagnetic energy of a first entry of the third pattern and the property of electromagnetic energy of a first entry of the fourth pattern;
with the first processing unit, determine a first count for the first index position based on counting the properties of electromagnetic energy of the first entry of the first pattern and of the first entry of the second pattern;
with the second processing unit, determine a second count for the first index position based on counting the properties of the electromagnetic energy of the first entry of the third pattern and of a first entry of the fourth pattern; and
with the aggregator processing unit:
determine the count for the first index position based on summing the first and second counts received from the first and second processing units; and
determine the sum value of the first value, the second value, the third value, and the fourth value based on the count and the multiplication factor for the first index position.

19. A method of performing a collective operation using electromagnetic energy, comprising:
for each node of a plurality of nodes of a layer of an artificial intelligence (AI) model:
determining a weighted input for the node;
generating an encoded electromagnetic signal representing the weighted input via a property of electromagnetic energy as a pattern of a set of entries; and
displaying the encoded electromagnetic signal on one or more displays;
detecting, at a plurality of sets of regions of interest, the property of electromagnetic energy of each entry of the encoded electromagnetic signals for the plurality of nodes, wherein each set of regions of interest corresponds to an index position of the patterns of each of the electromagnetic signals;
determining, for at least one index position, a count based on counting the properties of electromagnetic energy detected at the regions of interest of the set of regions of interest associated with the at least one index position;
determining a sum value of the values represented by the encoded electromagnetic signals of the plurality of nodes based on the count and a multiplication factor for the at least one index position; and
communicating the sum value to a receiving node of a receiving layer of the AI model.

20. The method of claim 19, further comprising communicating the sum value to the receiving node without communicating the weighted inputs for the plurality of nodes to the receiving node.
